(19) United States
(12) Patent Application Publication
(10) Pub. No.: US 2018/0292339 A1
(43) Pub. Date: Oct. 11, 2018

(54) SYSTEMS AND METHODS FOR HIGH RESOLUTION PLANT ROOT ZONE SOIL MAPPING AND CROP MODELING

(71) Applicant: PIONEER HI-BRED INTERNATIONAL, INC., Johnston, IA (US)

(72) Inventor: Robert Alan GUNZENHAUSER, Humeston, IA (US)

(73) Assignee: Pioneer HI-Bred International, Inc., Johnston, IA (US)

(21) Appl. No.: 15/526,183

(22) PCT Filed: Nov. 11, 2015
(86) PCT No.: PCT/US2015/060088

§ 371 Date: May 11, 2017

Related U.S. Application Data
(60) Provisional application No. 62/080,079, filed on Nov. 14, 2014.

(51) Int. Cl. G01N 27/04; G01N 21/3563; G01V 3/02; A01B 79/00; A01B 15/18; A01B 49/04

(52) U.S. Cl. CPC G01N 27/045; G01N 21/3563; A01B 49/04; A01B 79/005; A01B 15/18; G01V 3/02

(57) ABSTRACT

A system for measuring soil electrical conductivity having a support, a plurality of soil engaging contacts (e.g. coulters) mounted to the support, at least one probe, and a processor. Current is provided through the soil and then measured. The voltages measured between respective opposed pairs of contacts are used to calculate the soil electrical conductivity of the soil within first, second, and third depth ranges. Each probe is selectively inserted within the soil and is configured to determine the soil electrical conductivity of the soil within the first, second, and third depth ranges. The processor correlates the calculated soil electrical conductivity of the soil within the first, second, and third depth ranges with the soil electrical conductivity determinations of the probe. Methods of determining and imaging soil characteristics and applying those characteristics to a crop model are included.

### FIELD

This invention relates to systems and methods for finely mapping soil characteristics within a field, by using soil electrical conductivity measurements, and to methods for imaging the mapped data. The invention further relates to methods for determining soil characteristics and applying those characteristics to a crop model.

### BACKGROUND

Soil texture (the percentage of sand, silt, and clay particles in soil) is an important component in crop models, but is difficult to measure. Taking soil samples and having them analyzed by a laboratory is time consuming and expensive. Further, soil texture differences are not typically analyzed with sufficient resolution to determine if there is a depth gradient of different soil textures in a single field location. What is needed is a quick and efficient method to determine soil characteristics and to further classify soil texture for crop modeling purposes.

A system is disclosed in U.S. Patent Application Publication No. 2011/0106451 that uses sensors to measure soil EC in three dimensions. However, this existing system does not have sufficient resolution and accuracy to reliably identify three-dimensional variations in soil electrical conductivity that may occur within the 12-36 inch (about 30-90 cm) depth range, which are important depths for plant roots of certain crop species, nor does it provide guidance for methods of using information obtained from the system to determine soil texture and/or create a high resolution soil map as described herein.

### SUMMARY

Inaccuracies in soil texture measurements can have surprisingly large effects on crop model calculations, thereby causing inaccurate results in crop models used by farmers that result in the application of too much or too few agricultural inputs, such as nitrogen, water, phosphorous, potassium, biological amendments and/or seed. Accordingly, accurate high resolution maps of soil characteristics such as sand, silt and clay levels are extremely important for accurate crop modeling and precision agriculture.

The first step in accurate soil texture measurement is physical measurement of the soil. While typical soil sampling is the most accurate type of measurement, taking the number of samples needed to map farm management zones is expensive and time consuming. Soil electrical conductivity measurements provide a convenient way of determining the conductivity of the soil, but electrical conductivity characteristics do not directly result in the determination of soil texture (sand, silt and clay percentage) characteristics. Described herein, is a method for calculating soil texture based on a combination of electrical conductivity and soil moisture measurements. Additional temperature, compaction, organic matter and salinity measurements can be used to further increase the accuracy of the soil texture determination.

The inventors have further determined that the above measurements can be conveniently and cost effectively evaluated across management zone at three distinct depths within the first 36″ of the soil. Certain crops, such as corn, have a rooting depth within this span, with different critical phases of the crop's development being greatly affected by the soil characteristics within this depth. It has been determined that by using at least three distinct depths for crops such as corn, data can be obtained for crop models that allows the models to be utilized with a very high degree of accuracy. Surprisingly, the use of this improved data will show dramatically improved results across different types of crop models. By using the measurements and methods described herein, clay pan and/or gravel soil striations within this depth range can be detected, and management practices can be improved based on this information.

As an additional aspect of the invention, a method of efficiently traversing the field to obtain measurements in a time and resource efficient manner is described. After traversing the field in a first pass using voltage sensing contacts (e.g., coulters), an algorithm is used to determine where to subsequently probe the field to assess management zone soil differences. Additional probing and/or sampling is conducted in order to correlate the electrical conductivity values with the measured sand, silt and clay content of the soil in the field. The probe can be adapted to assess additional characteristics as well, such as soil temperature, salinity, compaction and/or organic matter.

With respect to the apparatus, described herein, in one aspect, is a system for measuring soil electrical conductivity in at least three distinct depths. The system can have a support and a plurality of soil engaging contacts (e.g., coulters) mounted to the support. The support can be configured to be conveyed over a ground surface. The plurality of contacts (e.g., coulters) can be insulated from the support and from one another. The plurality of soil engaging contacts (e.g., coulters) can include at least first, second, and third pairs of opposed contacts (e.g., coulters). The system can also have means for providing a current through the soil and means for measuring the current provided through the soil. Additionally, the system can have: means for measuring a voltage resulting from the current between the first pair of contacts (e.g., coulters); means for calculating the soil electrical conductivity of the soil within a first depth range using the voltage measurement between the first pair of contacts (e.g., coulters); means for measuring a voltage resulting from the current between the second pair of contacts (e.g., coulters); means for calculating the soil electrical conductivity of the soil within a second depth range using the voltage measurement between the second pair of contacts (e.g., coulters); means for measuring a voltage resulting from the current between the third pair of contacts (e.g., coulters); and means for calculating the soil electrical conductivity of the soil within a third depth range using the voltage measurement between the third pair of contacts (e.g., coulters). Further, the system can have at least one probe. Each probe can be configured for selective insertion within the soil, and the probe can be configured to determine the electrical conductivity of the soil within the first, second, and third depth ranges. The system can also have a processor. The processor can be positioned in communication with the at least one probe and the means for calculating the electrical conductivity of the soil within the first, second, and third depth ranges. The processor can be configured to correlate the calculated soil electrical conductivity of the soil within the first, second, and third depth ranges with the soil electrical conductivity determinations of the probe.

In another aspect, described herein is a method of determining soil texture based on the measured soil electrical conductivity, soil moisture, and optionally, soil temperature, salinity, organic matter and compaction at each distinct depth. The soil electrical conductivity can be measured by passing a current through the soil and/or probe, which can each be communicated to a processor. The method can further include measuring voltages resulting from the current between respective electrical contact members and communicating the measured voltages to the processor, and using the two distinct measurements to correlate their accuracy. Further, the method can include calculating, through the processor, the soil electrical conductivity of first, second, and third depth ranges of the soil using the voltage measurements between corresponding pairs of electrical contact members (e.g., coulters). Additionally, the method can include selectively inserting at least one probe within the soil at at least one probe insertion location, with each probe insertion location being positioned proximate a corresponding test measurement location. Also, the method can include measuring the soil electrical conductivity of the first, second, and third depth ranges of the soil using the probe and communicating the measured soil electrical conductivity of the first, second, and third depth ranges to the processor. Further, the method can include correlating, through the processor, the calculated soil electrical conductivity of the first, second, and third depth ranges of the soil at the at least one test measurement location with the soil electrical conductivity measurements of the probe at the at least one probe insertion location.

To further improve accuracy, a limited number of soil samples may be taken. At strategic locations in a field, a set of soil samples, each at the desired depth and range (0-12 inches, 12 to 24 inches, and 24 to 36 inches), may be removed and analyzed for soil texture in sand percentage (particle size is greater than 0.05 mm diameter), silt percentage (particle size between 0.002 and 0.05 mm diameter), and clay (particle size is less than 0.002 mm diameter). This classification is based on United States Department of Agriculture Soil Textural Classification System. In addition, the said soil sample may be analyzed for organic matter percentage, cation exchange capacity (CEC), and salinity (grams of salt per liter of water or kilograms of salt per cubic meter of water). In addition, the GPS coordinates (latitude and longitude) of the sample points are recorded by the computer, along with the present readings of the 0-12″, 12-24″, and 24-36″ EC values. Near the same location as the samples are taken (within about 6 inches), the probe is inserted into the soil at a constant rate, with electrical conductivity, soil temperature, soil moisture, and soil salinity being measured and recorded as the probe is being inserted. The probe may be inserted to 36″. These samples and measurements may be used to more accurately calibrate the electrical conductivity measurements taken for the various depths across the field. Further, the method can include calculating soil electrical conductivity by measuring the voltage drop between the pair of electrical contact members and the sensor on the probe as the probe is inserted into the soil and traverses the first, second, and third ranges. This provides an alternative method of determining soil electrical conductivity from using the surface electrical contact members only, and allows calibration measurements to be taken that can improve the accuracy of the instrument.

Utilizing the analyzed results of sand, silt, and clay percentages, organic matter, CEC, and salinity from soil samples taken at 3 depths at strategic locations in the field, along with the measured electrical conductivity from the coulters at three depths and the measured EC, moisture content, temperature and salinity from the probe, a computer algorithm is run using multi-variate linear regression statistics to determine linear predictor functions between measured contact (e.g., coulter) EC at various depths and analyzed sand, silt, and clay percentages, organic matter, and salinity and the coefficient of determination (R²). In doing so, a regression equation is developed, that estimates the sand, silt, and clay percentages, and optionally the organic matter, based on the contact (e.g., coulter) EC measurements and at the at least three measured depths in the soil. This equation is then applied to the measured contact (e.g., coulter) EC, thus creating texture, and optionally organic matter estimates at each point recorded while the vehicle is moving across the field. This spatial distribution of estimated values across a field at three different depths provides the user with detailed model of the soil properties that are most often used in determining soil water holding capacity, hydraulic conductivity, and bulk density. By utilizing the equations found in Saxton, K. E. and Rawls, W. J. (2006), Soil Water Characteristic Estimates by Texture and Organic Matter for Hydrologic Solutions, Soil Science Journal of America, Vol. 70, No. 5, p. 1569-1578, estimates of plant wilting point percentage of volume, field capacity percentage of volume, saturated percentage of volume, available water capacity, saturated hydrologic conductivity, and bulk density can be determined. These attributes, among others, may be utilized in various crop modeling software to provide information about the soil properties while running crop model simulations.

In order to group nearby points containing similar values into polygons that can accurately depict the values of points within it, a spatial clustering process called Super Linear Iterative Clustering (SLIC) may be employed. This method results in clusters, wherein each cluster will have a value assigned to it that is representative of the points located within it. Unlike super pixels for machine vision analysis and pattern recognition, which focus on creating clusters from raster images containing three bands (Red, Green, and Blue), the invention can use the SLIC process on a plurality of non-visual bands of data. For example, the estimated sand, silt and clay percentage, and optionally the soil organic matter and/or soil salinity, calculated at the at least three depths could all be converted into a raster file containing these as attributes. Each cell size could be adjusted by the user, but generally would be between about 1 to 5 meters each. In addition, topological data may be added to the raster file, including, but not limited to, elevation, slope percentage, curvature, Topographic Wetness Index, and other similar topographical attributes. These attributes are each treated as a “band” for the modified SLIC data clustering process. The output of the process would contain labels for cells of common clusters, along with statistics of average sand, silt, clay percentages, optionally organic matter % (all, each at the at least three depths). The output could further comprise topographical attributes for each cluster, such as elevation, slope, curvature, and topographic wetness index. A final process would spatially envelope the cells into polygons, each assigned with the proper identification. Although the above methods are described with respect to a SLIC data clustering process, it is contemplated that other conventional data clustering processes can be used in a similar manner. For example, it is contemplated that an ISO Cluster data clustering process can be used in place of, or in combination with, the SLIC data clustering process.

Additional advantages of the invention will be set forth in part in the description which follows, and in part will be obvious from the description, or may be learned by practice of the invention. The advantages of the invention will be realized and attained by means of the elements and combinations particularly pointed out in the appended claims. It is to be understood that both the foregoing general description and the following detailed description are exemplary and explanatory only and are not restrictive of the invention, as claimed.

### DETAILED DESCRIPTION OF THE FIGURES

These and other features of the preferred embodiments of the invention will become more apparent in the detailed description in which reference is made to the appended drawings wherein:

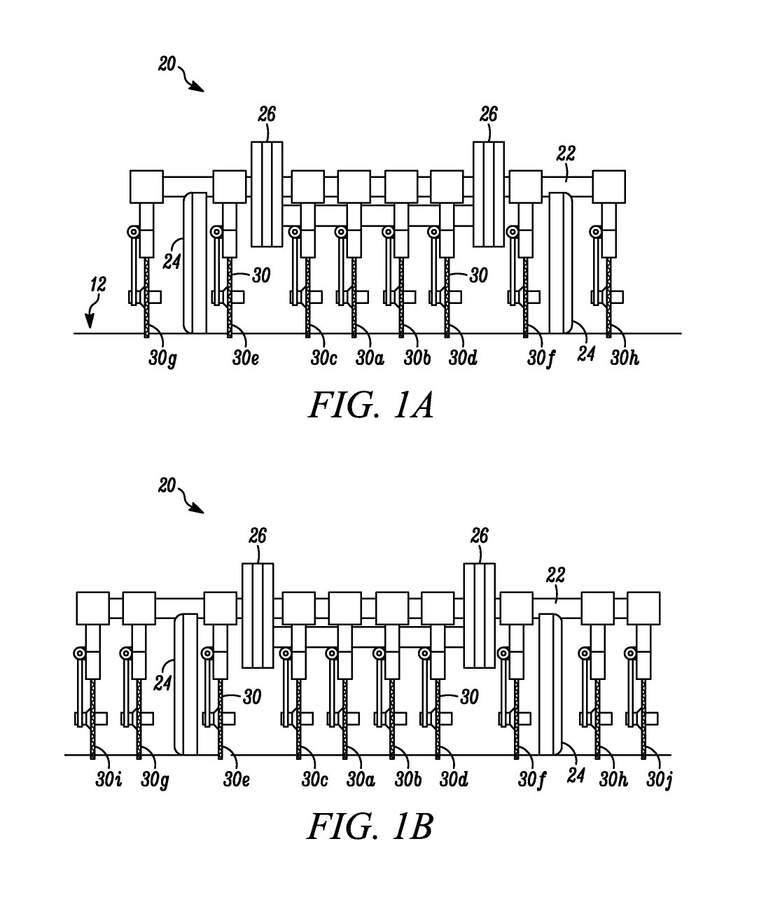

FIG. 1A is a front view of an exemplary soil EC measurement system as disclosed herein, which comprises measurement ranges for three depths. Two of the coulters are used to distribute an electrical charge into the soil, which is then measured by the remaining three sets of coulters. FIG. 1B is a front view of an exemplary soil EC measurement system as disclosed herein, which comprises measurement ranges for four depths. Two of the coulters are used to distribute an electrical charge into the soil, which is then measured by the remaining four sets of coulters. FIG. 1C is a front view of an exemplary soil EC measurement system as disclosed herein, showing a probe positioned in alignment with a center axis of a linear contact member array in between opposed contact members.

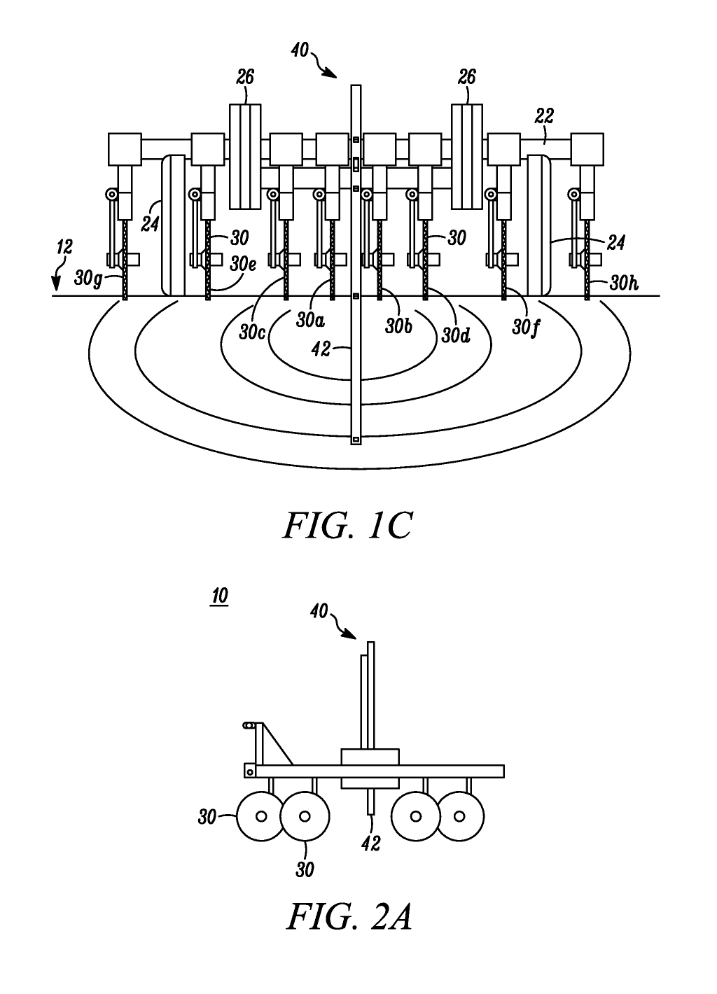

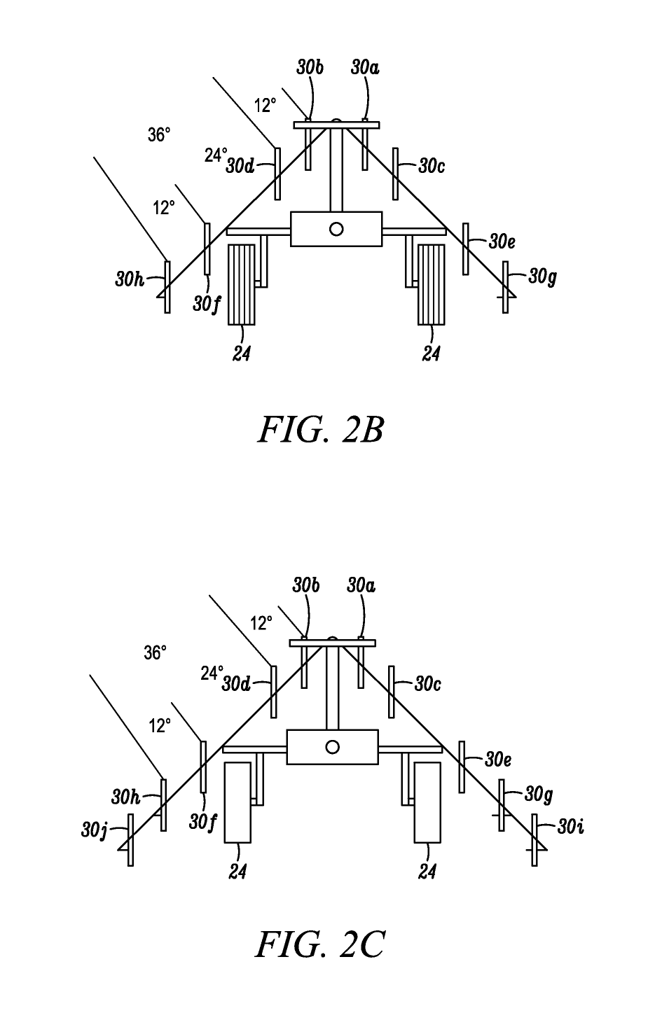

FIG. 2A is a view of an alternative arrangement for the EC measurement system. FIG. 2B is a view of an embodiment showing a pull cart with coulter discs, with this embodiment showing the probe of the invention mounted in the center of the cart, two of the coulter discs distributing an electrical charge, and three sets of coulters measuring the electrical charge as it passes through the soil. FIG. 2C is a view of an embodiment showing a pull cart with coulter discs, with this embodiment showing the probe of the invention mounted in the center of the cart, two of the coulter discs distributing an electrical charge, and four sets of coulters measuring the electrical charge as it passes through the soil.

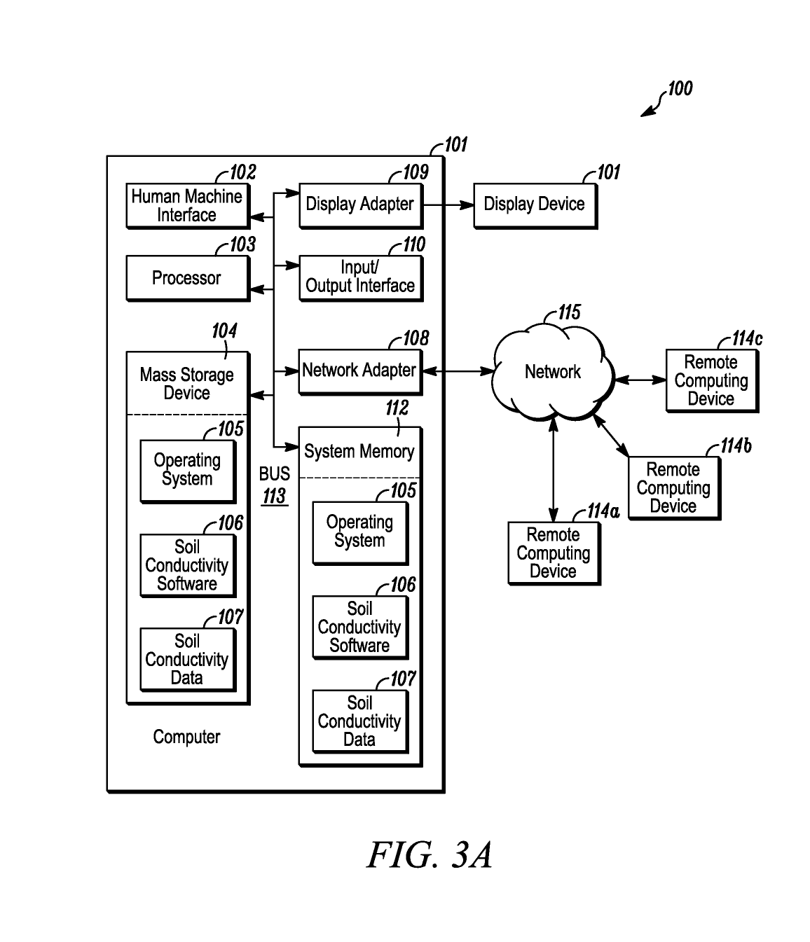

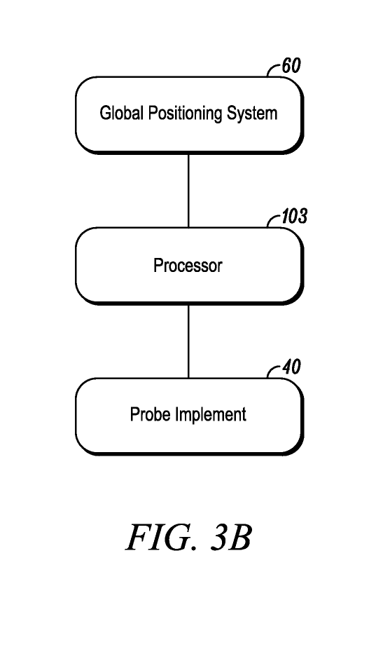

FIGS. 3A and 3B are flowcharts depicting an exemplary operating environment for use with the disclosed systems and methods.

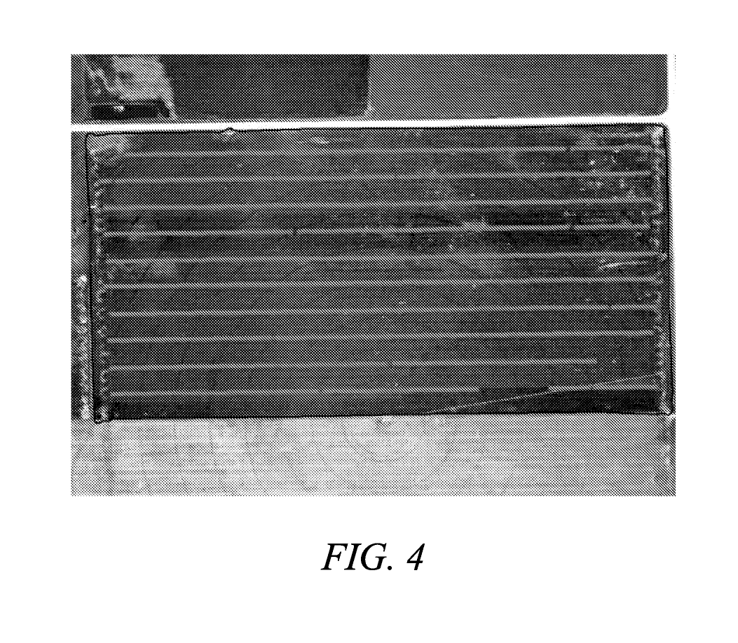

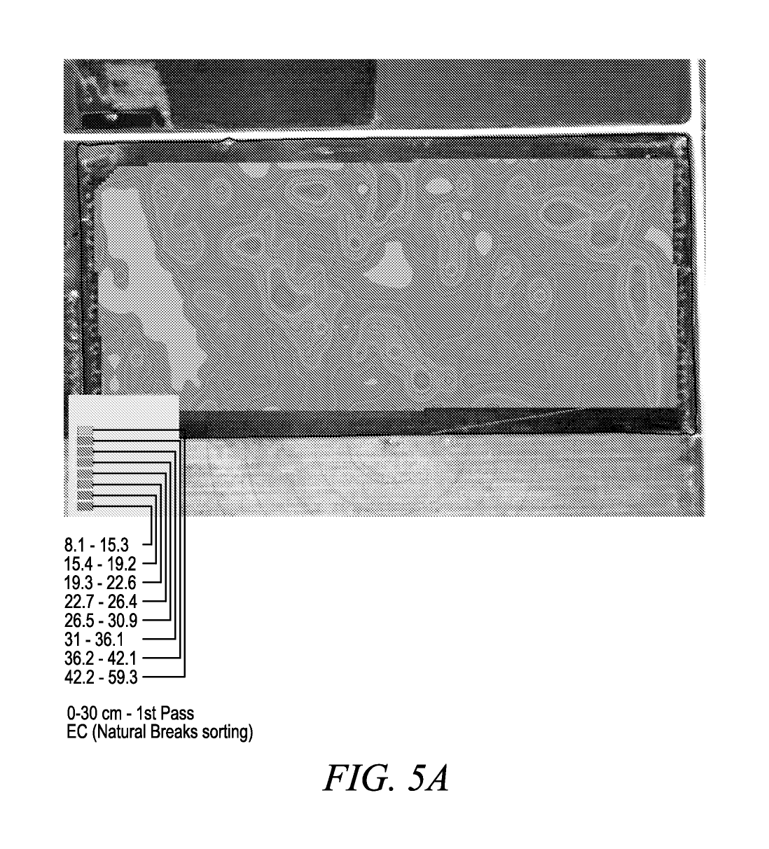

FIG. 4 shows the step of recording the 3 depths of EC together with latitude, longitude and elevation data. Transects in this image are 100 feet apart.

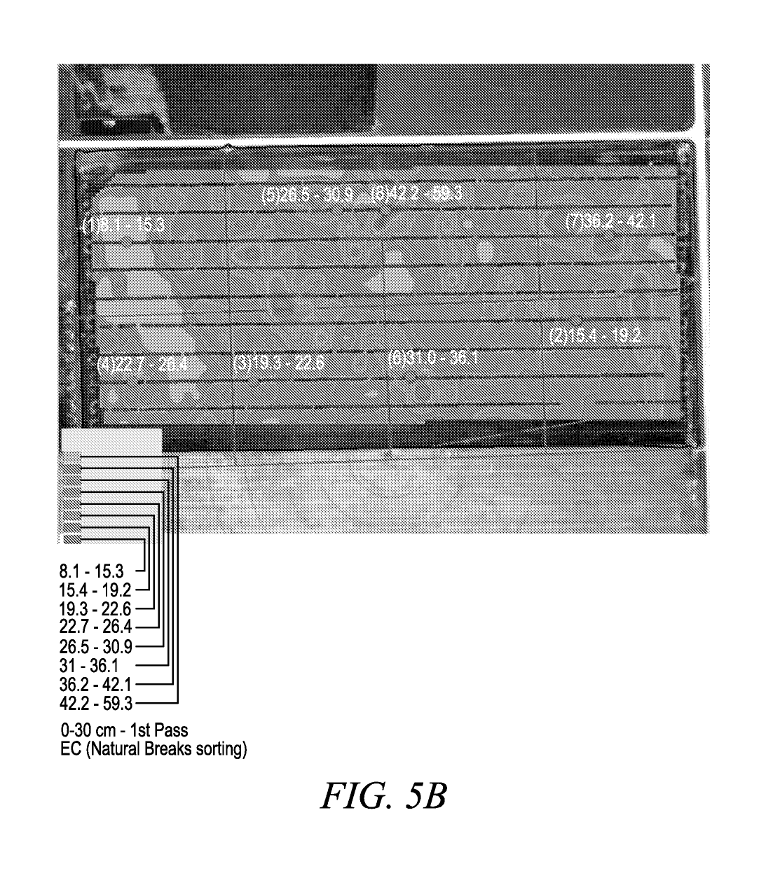

FIG. 5A is a soil map showing the interpolated results of the first pass shown in FIG. 4. The interpolated values are grouped into ranges using natural break sorting. FIG. 5B shows a grid placed over the field, with points for a planned second pass determined on transects that represent at least one of each range. These points may be used for subsequent probing and/or soil sampling.

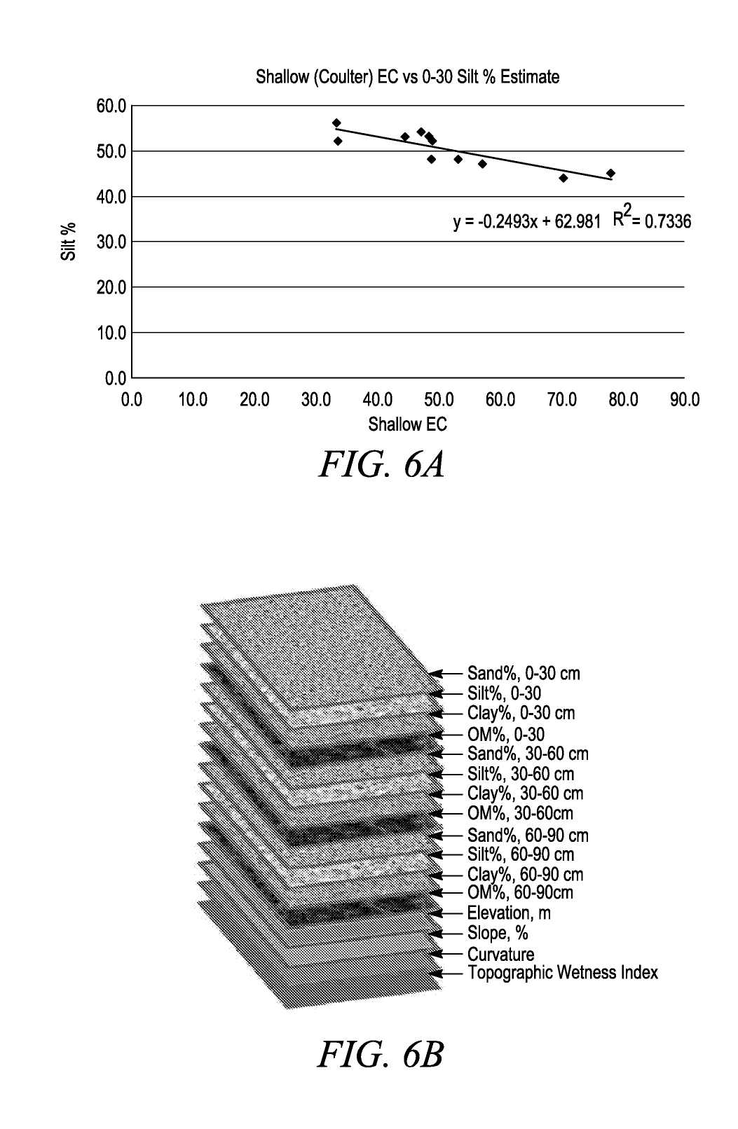

FIGS. 6A and 6B show the calculation of the estimates of sand/silt/clay for each of the at least three depths based on a regression analysis developed from the electrical conductivity data. Topographical attributes have also been converted into a two meter resolution raster format.

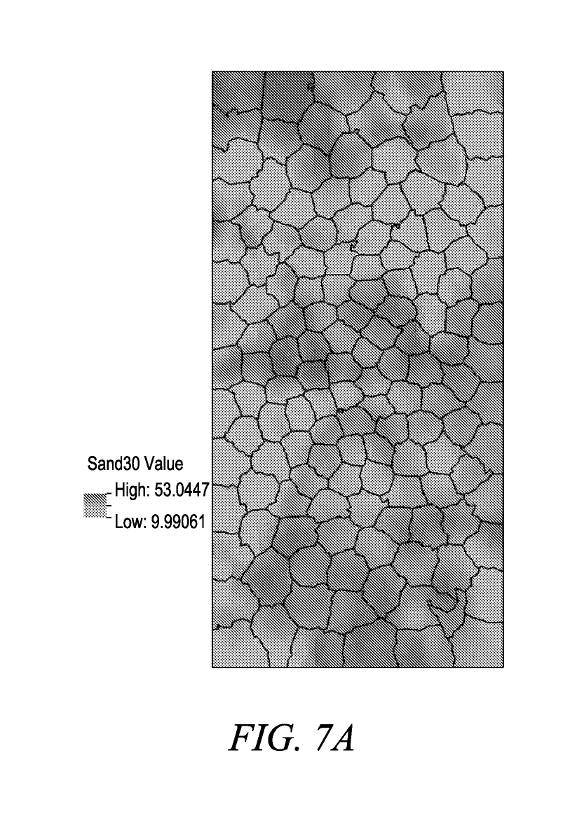

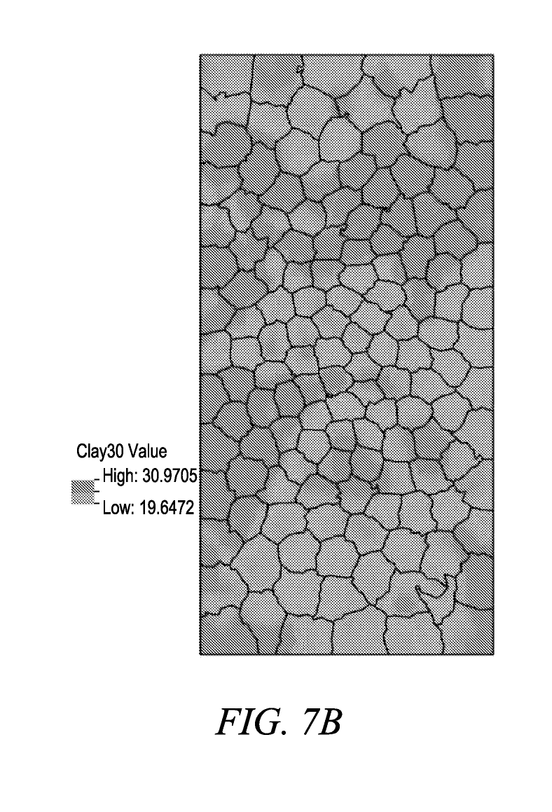

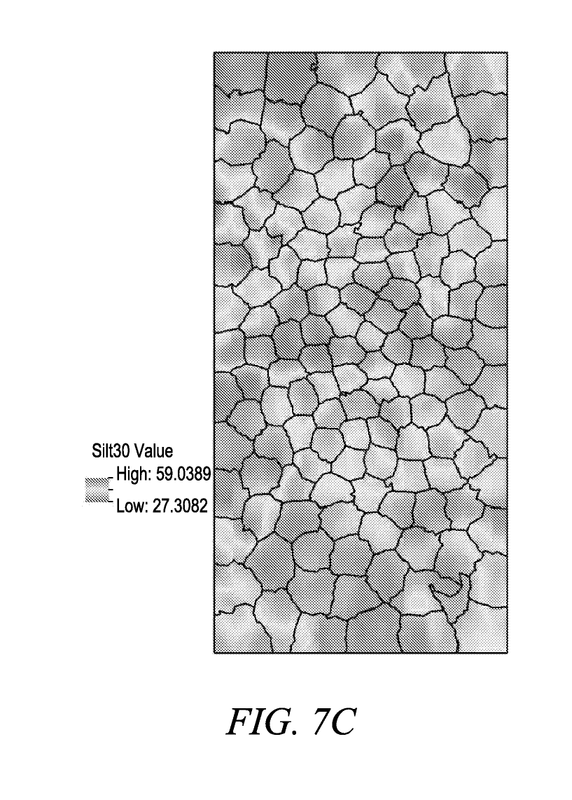

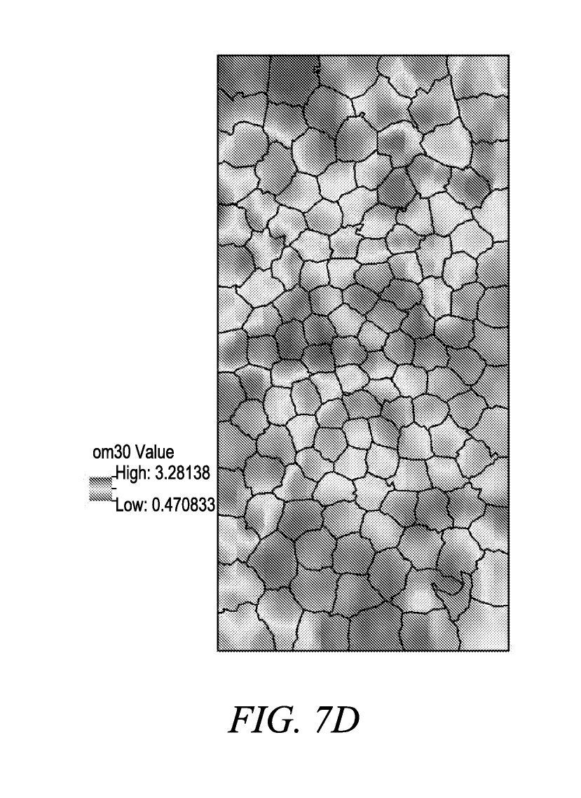

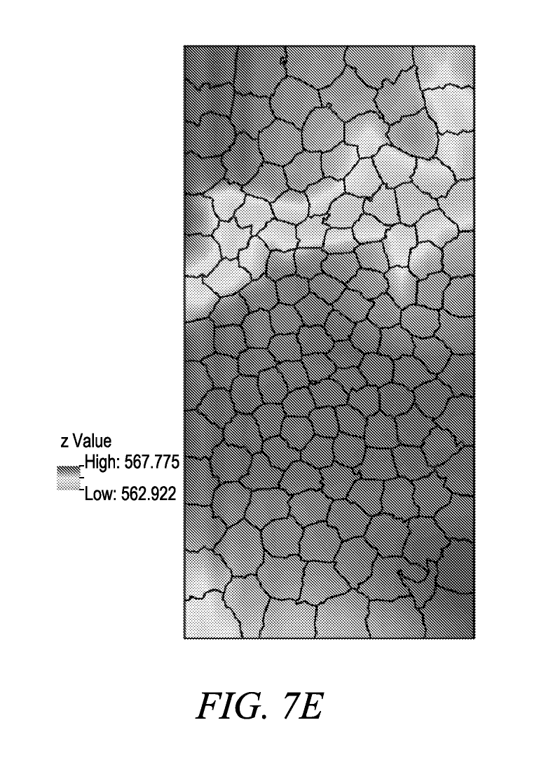

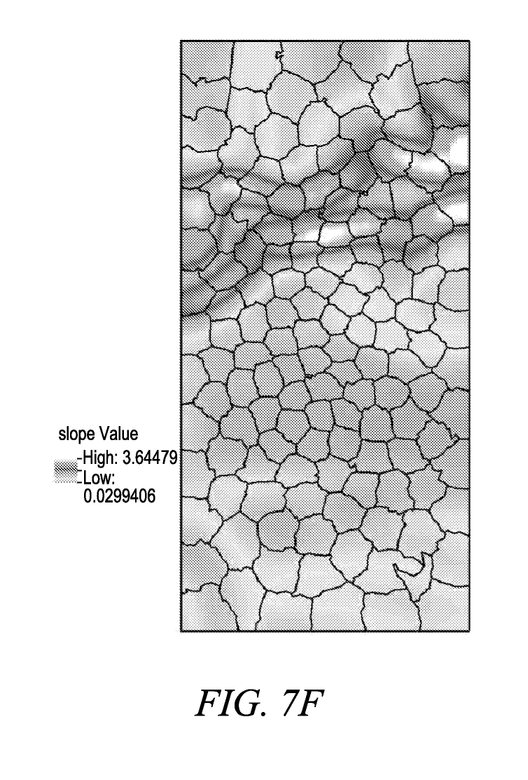

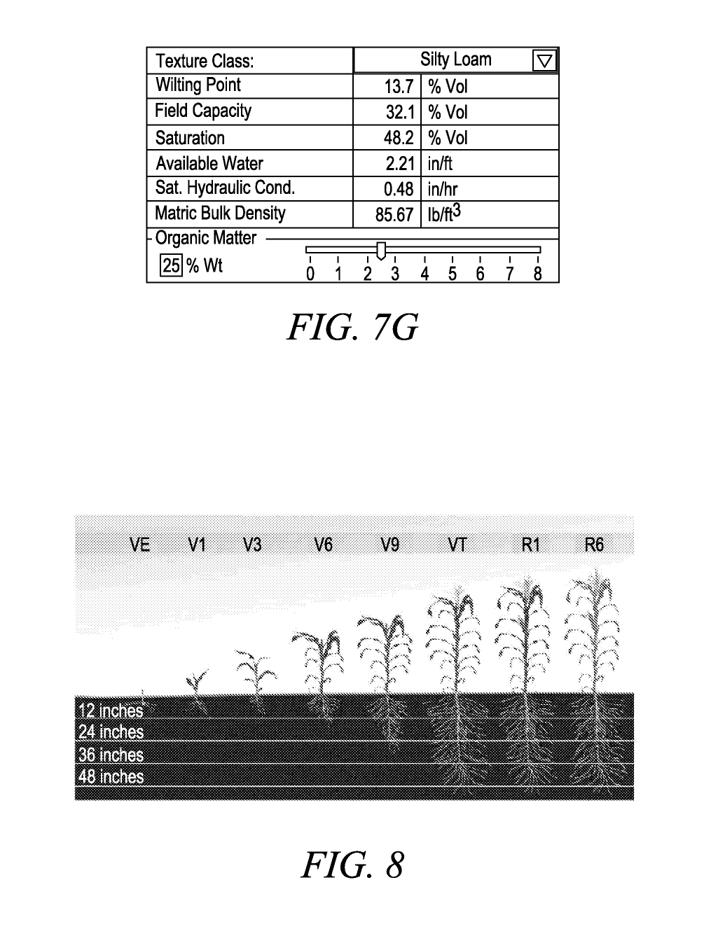

FIG. 7A shows the clustered polygons based on the soil texture and topographical attributes, with estimated sand percentage in the top 12″ displayed in the background to highlight correlation between the two outputs. FIG. 7B shows the clustered polygons based on the soil texture and topographical attributes, with estimated clay percentage in the top 12″ displayed in the background to highlight correlation between the two outputs. FIG. 7C shows the clustered polygons based on the soil texture and topographical attributes, with estimated silt percentage in the top 12″ displayed in the background to highlight correlation between the two outputs. FIG. 7D shows the clustered polygons based on the soil texture and topographical attributes, with estimated organic matter percentage in the top 12″ displayed in the background to highlight correlation between the two outputs. FIG. 7E shows the clustered polygons based on the soil texture and topographical attributes, with estimated elevation displayed in the background to highlight correlation between the two outputs. FIG. 7F shows the clustered polygons based on the soil texture and topographical attributes, with estimated slope displayed in the background to highlight correlation between the two outputs. FIG. 7G shows the attributes at each of the depths for each polygon, which data is used for crop modeling.

FIG. 8 is a root depth chart showing the formation and depth of roots at various stages of corn plant development.

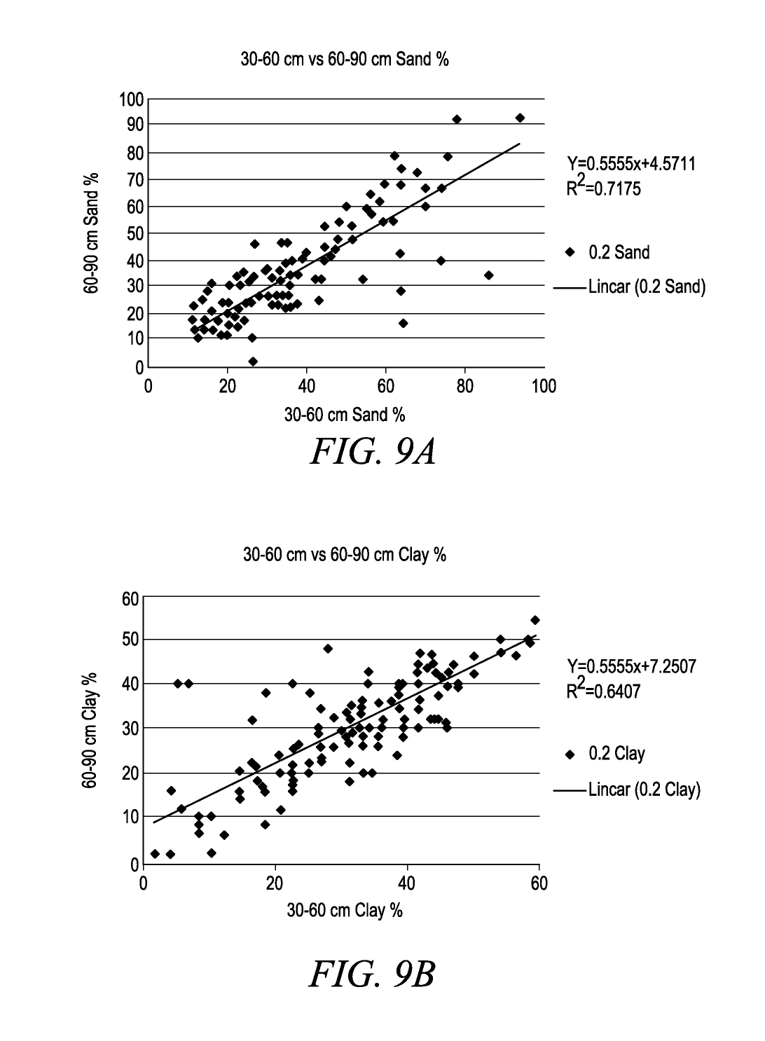

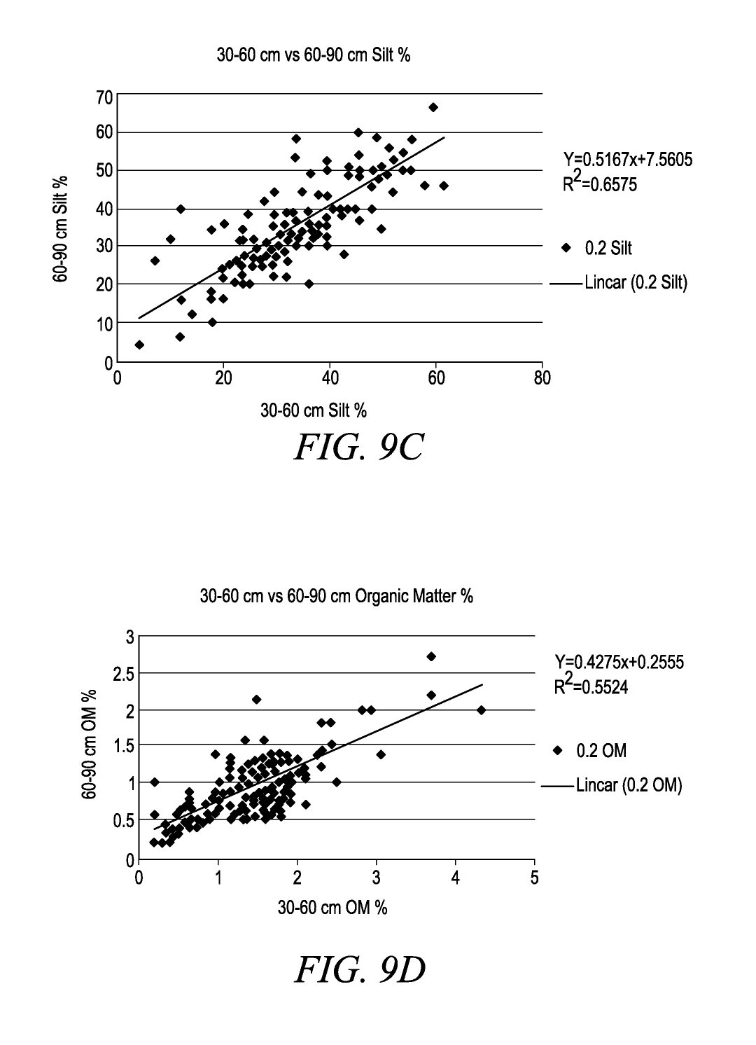

FIGS. 9A, 9B, 9C and 9D show a composite comparison of 30-90 cm vs. 30-60 cm and 60-90 cm depth values, and demonstrates the benefit of using a third soil depth range for crops with rooting zones spanning this depth range.

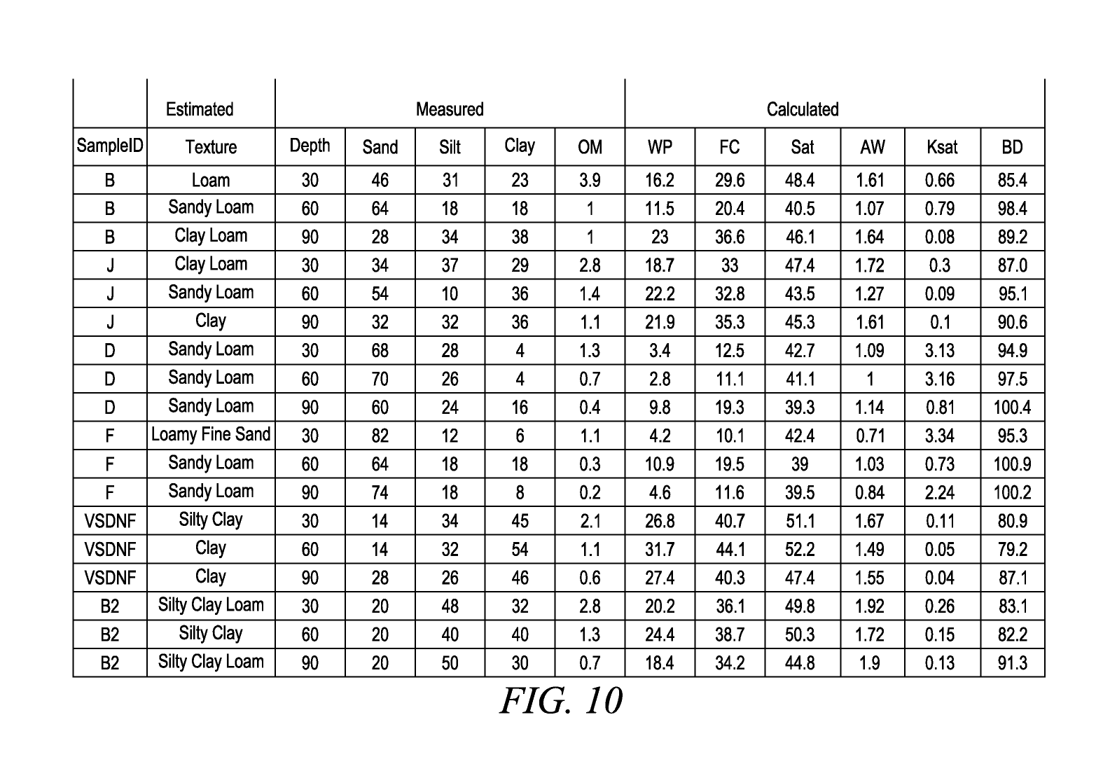

FIG. 10 shows the advantages of the additional (third) measurement in the 30-90 cm range and the effect of the improved accuracy resulting from such measurement on the calculated Available Water, K Sat, and Bulk Density calculations.

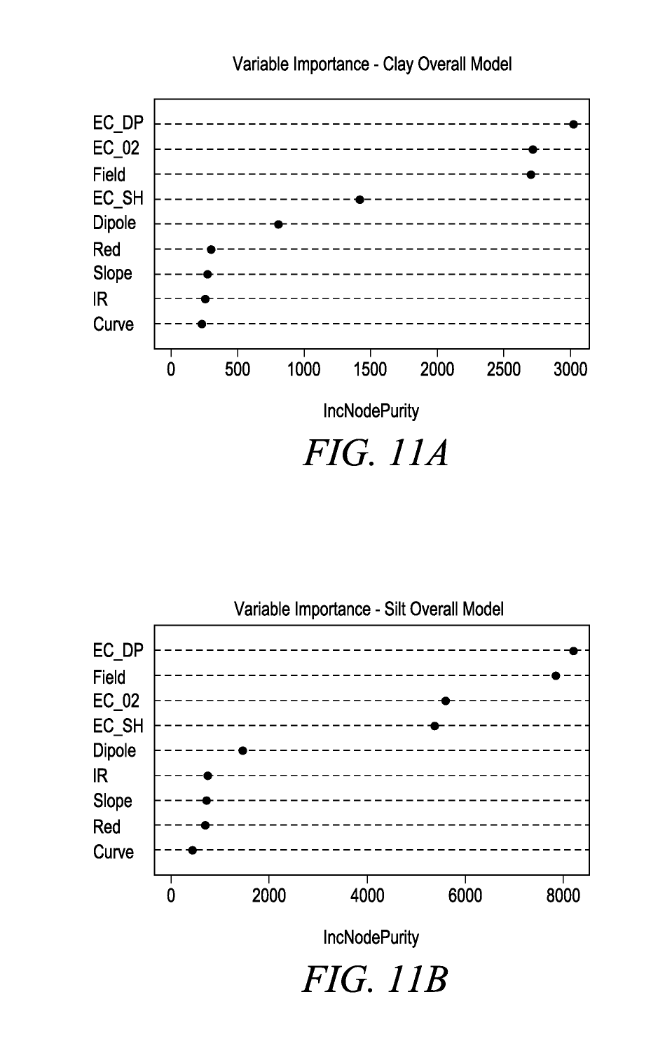

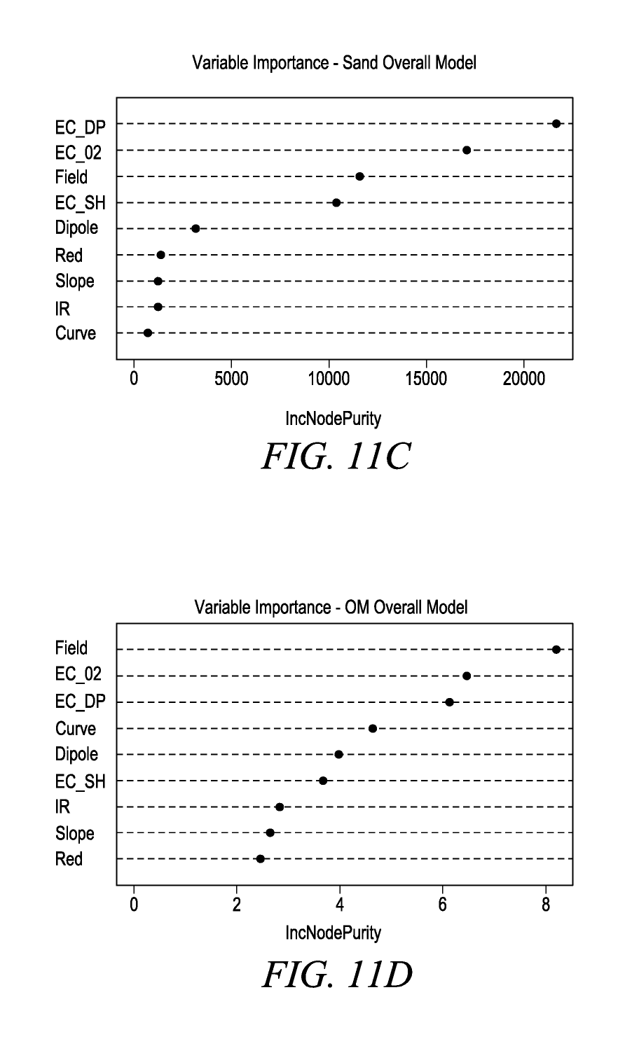

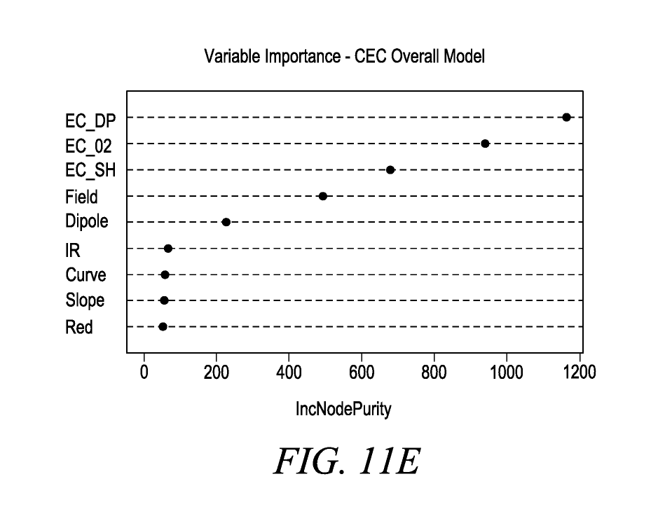

FIGS. 11A, 11B, 11C, 11D and 11E show the results of a 2015 field study. In general, EC measurements in the 0-36″ depth (labeled “EC_DP”) contributed the greatest level of variability explanation, followed closely by EC measurements at 0-24″ (labeled “EC_02”) and then EC measurements at 0-12″ (labeled “EC_SH”). This shows that EC measurements in the 0-24″ depth provided a significant contribution towards explaining variability.

The provisional application file contains at least one drawing executed in color. To comply with PCT filing rules, these drawings have been converted to black and white drawings, however, the color drawings in the provisional application file remain available for reference.

### DETAILED DESCRIPTION

The present invention can be understood more readily by reference to the following detailed description, examples, drawings, and claims, and their previous and following description. However, before the present devices, systems, and/or methods are disclosed and described, it is to be understood that this invention is not limited to the specific devices, systems, and/or methods disclosed unless otherwise specified, as such can, of course, vary. It is also to be understood that the terminology used herein is for the purpose of describing particular aspects only and is not intended to be limiting.

The following description of the invention is provided as an enabling teaching of the invention in its best, currently known embodiment. To this end, those skilled in the relevant art will recognize and appreciate that many changes can be made to the various aspects of the invention described herein, while still obtaining the beneficial results of the present invention. It will also be apparent that some of the desired benefits of the present invention can be obtained by selecting some of the features of the present invention without utilizing other features. Accordingly, those who work in the art will recognize that many modifications and adaptations to the present invention are possible and can even be desirable in certain circumstances and are a part of the present invention. Thus, the following description is provided as illustrative of the principles of the present invention and not in limitation thereof.

As used throughout, the singular forms “a,” “an” and “the” include plural referents unless the context clearly dictates otherwise. Thus, for example, reference to “a probe” can include two or more such probes unless the context indicates otherwise.

Ranges can be expressed herein as from “about” one particular value, and/or to “about” another particular value. When such a range is expressed, another aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint.

As used herein, the terms “optional” or “optionally” mean that the subsequently described event or circumstance may or may not occur, and that the description includes instances where said event or circumstance occurs and instances where it does not.

The word “or” as used herein means any one member of a particular list and also includes any combination of members of that list.

The term “contact” as used herein refers to any apparatus or device that is capable of conducting current that is passed through the soil as disclosed herein. In exemplary aspects, a contact can be a coulter as disclosed herein. However, it is contemplated that a contact can be any conventional apparatus or device for conducting current, including, for example and without limitation, a probe, a lead, and the like.

The term “interpolation” as used herein means the estimation of surface values at unsampled points based on known surface values of surrounding points. Interpolation can be used to estimate elevation, rainfall, temperature, chemical dispersion, or other spatially-based phenomena. Interpolation is commonly a raster operation. There are several well-known interpolation techniques, including natural neighbor, inverse distance weighting, spline, and kriging.

The term “natural breaks” as used herein means a method of manual data classification that seeks to partition data into classes based on natural groups in the data distribution. Natural breaks occur in the histogram at the low points of valleys. Breaks are assigned in the order of the size of the valleys, with the largest valley being assigned the first natural break.

The term “kriging” as used herein means an interpolation technique in which the surrounding measured values are weighted to derive a predicted value for an unmeasured location. Weights are based on the distance between the measured points, the prediction locations, and the overall spatial arrangement among the measured points. Kriging is unique among the interpolation methods in that it provides an easy method for characterizing the variance, or the precision, of predictions. Kriging is based on regionalized variable theory, which assumes that the spatial variation in the data being modeled is homogeneous across the surface. That is, the same pattern of variation can be observed at all locations on the surface.

The definitions of “interpolation,” “natural breaks,” and “kriging” are taken from the online “GIS Dictionary” (Esri), which is available online at http://support.esri.com/en/knowledgebase/Gisdictionary/browse, and which is based on “A to Z GIS: An Illustrated Dictionary of Geographic Information Systems”, edited by Shelly Sommer and Tasha Wade, ISBN: 9781589481404 (2006), which is incorporated by reference herein. Terms used herein which are defined in A to Z GIS: An Illustrated Dictionary of Geographic Information Systems shall have the meaning defined in such references.

As used herein, the term “depth range” refers to a range of distances below a ground surface, as measured from the ground surface. Thus, a depth range of 0 inches to 24 inches refers to the portion of soil extending from the ground surface to a position 24 inches below the ground surface.

As used herein, the term “soil electrical conductivity” means the electrical conductivity (EC) of a particular soil region. Thus, the terms “soil electrical conductivity,” “electrical conductivity,” and “EC” may be used interchangeably herein. As disclosed herein, current can be transmitted through a soil region, and pairs of opposed contacts can detect the voltage generated as the current is transmitted through the soil. As further disclosed herein, the current and voltage values can then be used with a calibration constant for the arrangement of opposed contacts to determine soil electrical conductivity.

As will be appreciated by one skilled in the art, the disclosed methods and systems can take the form of an entirely hardware embodiment, an entirely software embodiment, or an embodiment combining software and hardware aspects. Furthermore, the disclosed methods and systems can at least partially take the form of a computer program product on a computer-readable storage medium having computer-readable program instructions (e.g., computer software) embodied in the storage medium. More particularly, the disclosed methods and systems can take the form of web-implemented computer software. Any suitable computer-readable storage medium can be utilized including hard disks, CD-ROMs, optical storage devices, or magnetic storage devices.

Embodiments of the disclosed methods and systems are described below with reference to block diagrams and flowchart illustrations of methods, systems, apparatuses and computer program products. It will be understood that each block of the block diagrams and flowchart illustrations, and combinations of blocks in the block diagrams and flowchart illustrations, respectively, can be implemented by computer program instructions. These computer program instructions can be loaded onto a general purpose computer, special purpose computer, or other programmable data processing apparatus to produce a machine, such that the instructions which execute on the computer or other programmable data processing apparatus create a means for implementing the functions specified in the flowchart block or blocks.

These computer program instructions can also be stored in a computer-readable memory that can direct a computer or other programmable data processing apparatus to function in a particular manner, such that the instructions stored in the computer-readable memory produce an article of manufacture including computer-readable instructions for implementing the function specified in the flowchart block or blocks. The computer program instructions can also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

Accordingly, blocks of the block diagrams and flowchart illustrations support combinations of means for performing the specified functions, combinations of steps for performing the specified functions and program instruction means for performing the specified functions. It will also be understood that each block of the block diagrams and flowchart illustrations, and combinations of blocks in the block diagrams and flowchart illustrations, can be implemented by special purpose hardware-based computer systems that perform the specified functions or steps, or combinations of special purpose hardware and computer instructions.

Disclosed herein is an electrical conductivity system with paired contacts that can provide at least three distinct EC measurements in the 0-3 foot depth range. As shown in FIGS. 1A-1B, the paired contacts can comprise a plurality of soil engaging coulters; however, it is contemplated that any suitable contacts can be used in the manner disclosed herein. In an exemplary embodiment, the plurality of soil engaging coulters 30 can comprise at least a first pair of opposed coulters 30a, 30b, a second pair of opposed coulters 30e, 30f, and a third pair of opposed coulters 30g, 30h. Optionally, as shown in FIG. 1B, the plurality of soil engaging coulters 30 can comprise a fourth pair of opposed coulters 30i, 30j. Current may be injected into the soil by an array of opposed coulters, 30c, 30d, although any method for injecting current into the soil may be used. The voltage drops as the current flows through the soil, which is measured by pair of coulters with a span approximately equal to the depth to be measured. In the embodiment shown, the depths measured are 0-12 inches, 0-24 inches, 0-36, and 0-48 inches. However, it is understood that the 0-48 inch depth measurement is optional.

Alternatively, it is contemplated that at least one pair of opposed coulters can be offset from at least one other pair of opposed coulters relative to a longitudinal axis of the support 20. In still further exemplary aspects, the plurality of coulters 30 can be fluted counters having metal edges as described in U.S. Pat. No. 5,841,282 (the '282 Patent), which is incorporated herein by reference in its entirety. In additional exemplary aspects, it is contemplated that the plurality of coulters can be substantially evenly spaced relative to a longitudinal axis of the support.

Shown herein with reference to FIGS. 2A-2C is a system 10 for measuring soil electrical conductivity (EC) that can be adapted for use in carrying out the present invention. The system 10 may comprise a center mounted probe which will serve to distribute weight to the coulters 30 such that they are maintained in more continuous communication with the soil.

The plurality of coulters 30 can be mounted to the support 20 and insulated from the support and one another using any conventional means. The operative position of the plurality of coulters 30 can be selectively adjusted as is known in the art to control the depth to which the coulters penetrate into soil.

The system 10 comprises means for providing a current through the soil. In this aspect, it is contemplated that the means for providing a current can be any conventional current source as is known in the art. In exemplary aspects, the current source can comprise an electrical generator that is positioned in electrical communication with one of opposed coulters 30c, 30d. In these aspects, it is contemplated that the electrical communication between the electrical generator and the opposed coulters 30c, 30d can be provided by electrical wiring or other conventional circuit components.

The system 10 can comprise means for measuring a voltage resulting from the current between the first pair of coulters 30a-30b, the second pair of coulters 30e-30f, and the third pair of coulters 30g-30h. The means for measuring a voltage can comprise any conventional voltage measurement device as is known in the art, such as, for example and without limitation a sensor configured to measure voltage based upon current that is conducted by contacts as disclosed herein. In exemplary aspects, the sensor can be a transducer, a voltage detector, a voltmeter, and the like. The voltage measurement device can be electrically coupled to brackets or other portions of coulter pair by electrical wiring as described in the '282 Patent. The voltage measurement device can be electrically coupled to a data acquisition unit as is known in the art, which can, in turn, be positioned in electrical communication with the processor 103 as further disclosed herein. The system 10 can comprises means for calculating the soil electrical conductivity of the soil within a depth range using the voltage measurement between each set of coulter pairs. Optionally, as further disclosed herein and shown in FIG. 2C, a fourth pair of coulters 30i-30j can be provided, and the means for measuring the voltage resulting from the current between the first, second, and third pairs of coulters can be further configured to measure a voltage resulting from the current between the fourth pair of coulters.

Optionally, the system 10 can further comprise a reflectance module (not shown) as is known in the art, such as, for example and without limitation, a reflectance module as described in U.S. Patent Application Publication No. 2011/0106451 (the '451 Publication), which is hereby incorporated herein by reference in its entirety. The reflectance module can be adapted to measure any spectra. In particular, infrared spectra data can be utilized, including but not limited to data in the near and/or mid-IR range.

In a further aspect, and with reference to FIGS. 2A-2C, the system 10 can comprise a probe implement 40 having at least one probe 42. In this aspect, each probe 42 of the at least one probe can be configured for selective insertion within the soil. In operation, when the probe 42 is inserted into the soil, the probe can be configured to determine the soil electrical conductivity (EC) of the soil within the first, second, and third depth ranges. Optionally, in some aspects, the probe implement 40 (and the at least one probe 42) can be mounted to the support 20. Alternatively, the probe implement 40 (and the at least one probe 42) can be configured to be conveyed across the ground surface 12 separately from the support 20. For example, it is contemplated that the probe implement 40 can be configured for selective attachment to a vehicle. In exemplary aspects, it is contemplated that the probe 42 can be a sensor probe as described in the '451 Publication. Optionally, in some aspects, the probe 42 can be a Veris 4100 soil probe (Veris Technologies, Salina, Kans.). In other aspects, it is contemplated that the probe 42 can be a Geoprobe® Model 420M soil probe (Geoprobe Systems, Salina, Kans.). In some embodiments the probe would measure the same current being measured by one or more of the pairs of contacts. In this embodiment, only a single current source would be needed. Such current source may either be provided by the contact or by the probe itself. In the embodiment where the current source is provided by the contact, such as a coulter (e.g. 30c, 30d), the probe need not contain a current source. When the probe reaches the depth in the soil that is the depth measured by the one or more pairs of electrical contact members (one or more of (30a, 30b), (30e, 30f), (30g, 30h) (30i, 30j)), the equipment can be calibrated to improve its accuracy because each of the probe and the pair of electrical contact members would be measuring the voltage drop from a single current source. In one embodiment, the probe is approximately equidistant between at least one pair of electrical contact members, or between all pairs of electrical contact members. The probe may also be positioned approximately equidistant between the pair of contacts providing current (e.g. 30c, 30d). In one embodiment, such as is shown in FIGS. 2B and 2C, the probe is positioned such that it is approximately equidistant between the pair of contacts providing current (30d, 30d) and at least one or more of the pair of electrical contact members, such as (30a, 30b), (30e, 30f), (30g, 30h) that measure the voltage drop (or equidistant between all pairs of electrical contact members, as is shown in FIGS. 2B and 2C). As shown in FIG. 1C, in the event a linear contact member array is used, the probe may be positioned in the center axis of the linear array, between 30a and 30b.

In another aspect, and with reference to FIGS. 3A and 3B, the system 10 can comprise a processor 103. In this aspect, the processor 103 can be positioned in communication with the at least one probe 42 and the means for calculating the soil electrical conductivity of the soil within the first, second, and third depth ranges. In operation, the processor 103 can be configured to correlate the calculated soil electrical conductivity of the soil within the first, second, and third depth ranges with the soil electrical conductivity determinations of the probe 42.

Optionally, in an additional aspect, the system 10 can further comprise means for continuously measuring the moisture content of the soil within the first depth range. In this aspect, the at least one probe 42 can optionally be configured to measure the moisture content of the soil within the first, second, and third depth ranges. In further optional aspects, the at least one probe 42 can be further configured to measure the temperature of the soil within the first, second, and third depth ranges. Thus, in these aspects, it is contemplated that the at least one probe 42 can comprise a temperature sensor as is known in the art.

In exemplary aspects, the first depth range of the soil can correspond to a depth ranging from about 0 inches to about 12 inches, the second depth range of the soil can correspond to a depth ranging from about 0 inches to about 24 inches, and the third depth range of the soil can correspond to a depth ranging from about 0 inches to about 36 inches. In these aspects, the processor 103 can be configured to calculate the soil electrical conductivity within first, second, and third levels of the soil based upon the soil electrical conductivity measurements of the soil within the first, second, and third depth ranges. In further exemplary aspects, the first level of the soil can correspond to a depth ranging from about 0 inches to about 12 inches, the second level of the soil can correspond to a depth ranging from about 12 inches to about 24 inches, and the third level of the soil can correspond to a depth ranging from about 24 inches to about 36 inches. These depth ranges may be optimized for the plant species of interest, based on the depth and breadth of the plant′ root zone.

Optionally, in some aspects, as shown in FIG. 3B, the processor 103 can be positioned in operative communication with a global positioning system (GPS) 60 as is known in the art. In these aspects, the processor 103 can be configured to produce a map depicting changes in soil electrical conductivity across a field based on the calculated soil electrical conductivity at the first, second, and third levels.

Optionally, in further aspects, each probe 42 of the at least one probe can be configured to measure soil compaction using conventional techniques. In these aspects, it is contemplated that the at least one probe 42 can comprise a penetrometer as is known in the art. In further optional aspects, and with reference to FIGS. 2A-2B, each probe 42 of the at least one probe can be configured to selectively deploy a sample receptacle (or coring probe) into the soil to permit collection of a soil sample. In these aspects, it is contemplated that the collected soil samples can be analyzed and used to calibrate the probe and/or coulter electrical conductivity measurements with particular soil properties, such as sand, silt and clay and organic matter content. Optionally, it is contemplated that a Foss 6500 scanning monochromator (Foss NIRSystems, Silver Spring, Md.) can be used to obtain the sand, silt, clay, and organic matter content using near infrared measurements. An exemplary method for using the Foss 6500 scanning monochromator to obtain near infrared measurements is disclosed in Chang et al., “Near-Infrared Reflectance Spectroscopy—Principal Components Regression Analyses of Soil Properties,” Soil Sci. Soc. Am. J. 65:480-490 (2001), which is hereby incorporated by reference herein in its entirety. It is further contemplated that GPS location data can be matched with the probe measurements at each insertion location. An exemplary sample receptacle (or coring probe) is disclosed in the '451 Publication.

Optionally, in exemplary aspects, the at least one probe may comprise an optical sensor that could directly identify the textural components of the soil, such as the sand, silt and clay content at the various depth ranges, which could remove the step of requiring a soil sample for calibration. Calibration could then occur soon after the completion of the traversal of the system through the field and/or the practice of the method. Optical sensors that could be used include an optical camera and/or an infrared sensor. One such sensor that could be used is a 4-Sensor probe by Veris technologies, Salina Kans., which acquires spectral measurement in the visible and near-infrared range, along with soil electrical conductivity and insertion force at the probe moves through the soil. It is contemplated that reflectance at particular wavelengths can vary due to changes in soil texture. Near infrared sensors typically measure wavelengths in the 0.75-2.5 μm range.

Optionally, a mid-range infrared sensor could also be used, which sensor measures spectra in the 2.5-20 μm range, which includes the OH/CH region (from 2.5-5 μm and the fingerprint region from 5-15 μm). Mid-range infrared sensors have advantages over those that measure the near infrared range, which often has overtones of the fundamental bands residing in the mid-IR region. As a result, measurement of these bands tends to be weak and not clearly delineated. In contrast, sand, silt, clay, and organic matter have well delineated absorption bands in the mid-IR spectral region, and the mid-IR spectra of mixtures are often additive. This means that individual components in a mixture, such as a mixture of sand, silt and clay, may be isolated from other bands and can be used to quantify the individual components of the mixture by the strength of their absorption. In exemplary aspects, the at least one probe can comprise at least one mid infrared sensor. Optionally, in these aspects, the at least one probe does not comprise a near infrared sensor, because of the advantages of the Mid-IR range for measuring soil texture (sand, silt, and clay) and organic matter content described herein. In further exemplary aspects, the at least one probe can be configured to measure reflectance within only a mid infrared wavelength range. That is, in these aspects, the optical sensor of the at least one probe does not measure spectra outside the mid-infrared spectral range. An exemplary method of using mid infrared measurements to analyze soil is described in Janik et al., “Can mid infrared diffuse reflectance analysis replace soil extractions?” Australian Journal of Experimental Agriculture 38(7) 681-696 (1998), which is hereby incorporated herein by reference in its entirety.

Optionally, in exemplary aspects, the at least one probe can comprise both a near infrared and a mid infrared sensor, or multiple probes with these capabilities can be used. Thus, in these aspects, the at least one probe can be configured to measure reflectance at wavelengths falling within the near infrared and mid infrared ranges. An exemplary method of performing combined diffuse reflectance spectroscopy for both visible, near infrared, and mid infrared wavelengths is described in Rossel et al., “Visible, near infrared, mid infrared or combined diffuse reflectance spectroscopy for simultaneous assessment of various soil properties,” Geoderma 131(1-2) 59-75 (2006), which is hereby incorporated herein by reference in its entirety.

Optionally, it is contemplated that the at least one probe can be used to detect and/or measure soil texture following appropriate calibration. For example, in some aspects, soil samples can be obtained and then preserved in their natural state (moist, unbroken, etc.). For each preserved sample, a first portion of the sample can be sent to a lab for reference analysis using conventional methods while a second portion of the sample can undergo full infrared spectrum measurement using conventional methods. After sufficient samples are analyzed, it is contemplated that conventional processing /or analysis methods can be applied to identify particular wavelengths that provide an indication of sand, silt, clay, organic matter, and the like. It is further contemplated that the at least one probe can be operatively coupled to one or more filters to focus the probe measurements on the wavelengths that are associated with sand, silt, clay, organic matter, and the like. In further exemplary aspects, the at least one probe and its associated filters can be provided as a freestanding device.

Optionally, in exemplary aspects, and with reference to FIGS. 2A-2C, each probe 42 of the at least one probe can comprise a force sensor configured to measure an insertion force required to insert the probe into the soil. Optionally, it is further contemplated that each probe 42 can comprise a moisture sensor as is known in the art. Optionally, it is still further contemplated that each probe 42 can comprise a visible light sensor as is known in the art. Optionally, as further disclosed herein, it is still further contemplated that each probe 42 can comprise a near-infrared (NIR) and/or mid infrared (MIR) light sensor as is known in the art. Thus, in combination, it is contemplated that the sensors of the probe 42 can be configured to measure soil moisture, EC, color, and claypan depth. Optionally, in further exemplary aspects, each probe 42 can comprise a salinity sensor as known in the art. In these aspects, the salinity sensor can be configured to produce an output indicative of the salinity of soil where the probe 42 is inserted. It is contemplated that each sensor of the probe 42 can be positioned in operative communication with the processor 103 as disclosed herein.

Optionally, in some exemplary aspects, and with reference to FIG. 1C and FIG. 2C, the plurality of coulters 30 can further comprise a fourth pair of opposed coulters 30i, 30j. In one embodiment, the fourth pair of opposed coulters 30i, 30j can be positioned at a distance of approximately 48″, thereby measuring the electrical conductivity at the lower level of the root zone area of certain plant species, such as corn. Optionally, in exemplary aspects, it is contemplated that the fourth pair of opposed coulters can be offset from the other pairs of opposed coulters relative to a longitudinal axis of the support 20. In these aspects, it is further contemplated that the first, second, and third pairs of opposed coulters can be substantially axially aligned relative to the longitudinal axis of the support 20 in a number of different arrays known in the art, such a Schlumberger array, a Wenner array, or combination of the above.

Although described herein as comprising a plurality of coulters, it is contemplated that one or more shank elements as are known in the art can be used to obtain the measurements disclosed above as being obtained by the coulters. Exemplary shank elements are described in the '451 Publication.

### Methods of Measuring Soil Electrical Conductivity

Soil electrical conductivity (C) can be calculated from these current (I) and voltage (V) measurements using the following formula:

C=k×I/V

where k is a calibration constant that depends upon the spacing of the coulter array and which can be calculated in a manner well-known to one of ordinary skill in the art.

Methods of measuring soil electrical conductivity are also disclosed. In one aspect, a method of measuring soil electrical conductivity can comprise passing a current through the soil at at least one test measurement location. In another aspect, the method can comprise measuring the current passed through the soil. In an additional aspect, the method can comprise communicating the measured current to a processor. In a further aspect, the method can comprise measuring voltages resulting from the current between respective electrical contact members. In still another aspect, the method can comprise communicating the measured voltages to the processor. In a further aspect, the method can comprise calculating, through the processor, the soil electrical conductivity of first, second, and third depth ranges of the soil using the voltage measurements between corresponding pairs of electrical contact members. In yet another aspect, the method can comprise selectively inserting at least one probe within the soil at at least one probe insertion location. In this aspect, each probe insertion location can be positioned proximate a corresponding test measurement location. In a further aspect, the method can comprise measuring the soil electrical conductivity of the first, second, and third depth ranges of the soil using the probe. In this aspect, it is contemplated that the probe can be inserted to three different depths at a given probe insertion location, with a first depth falling within the first depth range, a second depth falling within the second depth range, and a third depth falling within the third depth range. In an additional aspect, the method can comprise communicating the measured soil electrical conductivity of the first, second, and third depth ranges to the processor. In still another aspect, the method can comprise correlating, through the processor, the calculated soil electrical conductivity of the first, second, and third depth ranges of the soil at the at least one test measurement location with the soil electrical conductivity measurements of the probe at the at least one probe insertion location. Thus, it is contemplated that the electrical contact members (e.g., coulters 30 as disclosed herein) can be configured to continuously measure EC at the first, second, and third depth ranges, whereas the probe can measure EC at the first, second, and third depth ranges when it is selectively inserted at the probe insertion locations.

Following correlation between the probe measurements and the measurements of the electrical contact members, the processor can perform a regression analysis to calculate optimized soil electrical conductivity calculations for the first, second, and third depth ranges based upon the soil electrical conductivity values measured by the electrical contact members (e.g., coulters). It is further contemplated that the processor can be configured to use the calculated optimized soil electrical conductivity calculations to determine the relative proportion of sand, clay, and/or silt within the soil, such as, the sand and clay percentages within each of the first, second, and third depth ranges. It is still further contemplated that the processor can be configured to determine water flow/drainage characteristics within the soil based on the determined relative proportions of sand, clay, and/or silt.

In exemplary aspects, as further disclosed herein, the first depth range of the soil can correspond to a depth ranging from 0 inches to about 12 inches, the second depth range of the soil can correspond to a depth ranging from 0 inches to about 24 inches, and the third depth range of the soil can correspond to a depth ranging from 0 inches to about 36 inches. Optionally, in these aspects, the method can further comprise calculating, through the processor, the soil electrical conductivity within first, second, and third levels of the soil based upon the soil electrical conductivity measurements of the soil within the first, second, and third depth ranges. As further disclosed herein, it is contemplated that the first level of the soil can correspond to a depth ranging from about 0 inches to about 12 inches, the second level of the soil can correspond to a depth ranging from about 12 inches to about 24 inches, and the third level of the soil can correspond to a depth ranging from about 24 inches to about 36 inches.

Optionally, in additional aspects, the method can further comprise calculating, through the processor, the soil electrical conductivity of the first, second, and third depth ranges of the soil at at least one selected measurement location using voltage measurements between the corresponding pairs of electrical contact points. In further aspects, the method can comprise optimizing, through the processor, the calculated soil electrical conductivity of the first, second, and third depth ranges of the soil at the at least one selected measurement location based upon the correlation between the calculated soil electrical conductivity of the first, second, and third depth ranges of the soil at the at least one test measurement location and the soil electrical conductivity measurements of the probe at the at least one probe insertion location. Optionally, in these aspects, the method can further comprise continuously measuring the moisture content of the soil within the first depth range. As further disclosed herein, the probe can be configured to measure the moisture content of the soil at the first, second, and third depth ranges. Thus, in exemplary aspects, the step of selectively inserting the probe within the soil can comprise measuring the moisture content of the soil at the first, second, and third depth ranges. In further exemplary aspects, as further disclosed herein, the probe can be further configured to measure the temperature of the soil at the first, second, and third depth ranges. In these aspects, the step of selectively inserting the probe within the soil can comprise measuring the temperature of the soil at the first, second, and third depth ranges. These moisture and temperature measurements may be used to correlate the soil electrical conductivity measurements with known soil (sand/silt/clay) textures, thereby increasing the ability of the electrical conductivity measurements to accurately predict soil texture in other parts of the field.

Optionally, in other exemplary aspects, the method can comprise calculating soil electrical conductivity by measuring the voltage drop between a pair of electrical contacts and a sensor on the probe as the probe is inserted into the soil and traverses the first, second, and third depth ranges. It is contemplated that this alternative method does not determine soil electrical conductivity from using the surface electrical contact members only. It is further contemplated that this method can allow calibration measurements to be taken that can improve the accuracy of the instrument. An exemplary system for performing this alternative method is depicted in FIG. 1C.

Optionally, in another aspect, and as further disclosed herein, each probe of the at least one probe can be configured to measure soil compaction. In this aspect, the method can further comprise measuring soil compaction at the at least one probe insertion location using the at least one probe. Soil compaction may also affect electrical conductivity measurements, and correlating compaction level with the soil texture further increases the ability of the electrical conductivity measurement to predict soil texture.

Optionally, in an additional aspect, and as further disclosed herein, each probe of the at least one probe can comprise a sample receptacle. In this aspect, the method can further comprise selectively deploying the sample receptacle of a probe into the soil to permit collection of a soil sample at a corresponding probe insertion location.

Optionally, in another aspect, and as further disclosed herein, each probe of the at least one probe can comprise a force sensor. In this aspect, the method can further comprise measuring an insertion force required to insert a probe into the soil at a corresponding probe insertion location.

Optionally, in another aspect, and as further disclosed herein, each probe of the at least one probe can comprise a moisture sensor. In this aspect, the method can further comprise measuring soil moisture content at a corresponding probe insertion location.

Optionally, in another aspect, and as further disclosed herein, each probe of the at least one probe can comprise a salinity sensor. In this aspect, the method can further comprise measuring salinity at a corresponding probe insertion location. These salinity measurements may be used to correlate the soil electrical conductivity measurements with known soil (sand/silt/clay) textures, thereby increasing the ability of the electrical conductivity measurements to accurately predict soil texture in other parts of the field.

Optionally, in another aspect, each probe of the at least one probe can be configured to measure a proportion of organic matter within the soil using conventional methods.

In exemplary aspects, the method can further comprise selectively conveying a support over a ground surface. In these aspects, as further disclosed herein, the plurality of electrical contact members can be secured to a plurality of soil engaging coulters, the plurality of soil engaging coulters can be mounted to the support, and the plurality of coulters can be insulated from the support and from one another. Optionally, the plurality of soil engaging coulters can comprise at least first, second, and third pairs of opposed coulters. In one aspect, the step of measuring voltages resulting from the current between respective electrical contact members can comprise measuring a voltage resulting from the current between the first pair of coulters. In this aspect, the step of measuring voltages resulting from the current between respective electrical contact members can further comprise measuring a voltage resulting from the current between the second pair of coulters. It is contemplated that the step of measuring voltages resulting from the current between respective electrical contact members can still further comprise measuring a voltage resulting from the current between the third pair of coulters.

Optionally, in exemplary aspects, the method can further comprise attaching the support to a vehicle. In these aspects, the step of selectively conveying the support over the ground surface can comprise advancing the vehicle over the ground surface.

Optionally, in additional exemplary aspects, and as further disclosed herein, the processor can be in operative communication with a global positioning system. In these aspects, the method can further comprise producing, through the processor, a map depicting changes in soil electrical conductivity across a field based on the calculated soil electrical conductivity at the first, second, and third levels.

FIG. 4 shows a pattern for gathering the initial pass of data collection. At regular intervals, which may be at every 1-1000 feet, but preferably at about every 25, 50, 75, 100, 150, 200, 250 or 300 feet, electrical conductivity analysis for each of the at least three depths is conducted. GIS data indicating latitude, longitude and elevation may also be collected during the electrical conductivity analysis.

Following the first pass of data collection, the electrical conductivity values are interpolated by any of a number of methods known to one of ordinary skill in the art. In the example shown, natural break sorting was used. The sorted ranges are graphically illustrated in FIG. 5A.

A second pass of data collection is then conducted. In order to gather data from each range, points are determined based on larger grid transects. The transects shown are based on a 10 acre grid placed over the field (FIG. 5B). Any size grid may be used, although optimally a grid that captures at least one point in each range should be used. During this pass, additional EC and GIS data is collected, along with sensor probe data measurements such as soil moisture, temperature, compaction, organic matter, microbial composition and salinity measurements. Soil samples may also be taken at each of these locations. Of course, such data collection need not be limited to these locations, however, by using this method of sampling one can identify sufficient information about each range with an efficient amount of additional data collection. Advantageously, no prior soil data about the field or reference soil data (such as a reference soil map such as United States Department of Agriculture Natural Resources Conservation Service (USDA NRCS) Soil Survey Geographic Database (SSURGO)) is needed to determine the soil texture and other characteristics of the present invention.

As shown in FIGS. 6A-6B, a regression analysis is then conducted to calculate the soil texture for each point at each depth measured. Although this method is suited for measuring at least three soil depths, it is not so limited, and could be also be used with measurements of one or two soil depths, or even four, five, six or more soil depths.

As shown in FIGS. 7A-7B, these attributes are then clustered. While any means of clustering known in the art may be used (e.g., ISO Cluster), the modified version of Super Linear Iterative Clustering (SLIC) may be used to efficiently group points of similar characteristics at a useful level of resolution.

An exemplary SLIC process is disclosed in Achanta et al., “Group pixels into perceptually meaningful atomic regions which can be used to replace the rigid structure of a pixel grid,” Ecole Polytechnique Federale de Lausanne (2012), and Achanta et al., “SLIC Superpixels Compared to State-of-the-art Superpixel Methods,” Ecole Polytechnique Federale de Lausanne (2011), which are each incorporated herein by reference in their entirety. However, unlike in Achanta, the clustering for the present invention is based on data points and not RGB color pixels. Accordingly, the x, y and z coordinates serve as a proxy for the pixel size, and the data points may be clustered together spatially, with each respective cluster having values that represent zones and depth ranges of the field that have similar soil characteristics. For incorporating the soil values into a SLIC arrangement, it is necessary to modify the underlying software code to handle the additional data and plane of measurement. The soil measurements data, recorded in points, is then converted into a raster (grid) using an interpolation method. Any interpolation method known in the art maybe used. In the Figures shown, the “nearest neighbor” method of ARCGIS software (Esri) was applied, but other interpolation methods including kriging could be used. Once each attribute data set is converted to a raster, the “layers” are “stacked” together and processed by the SLIC process. Instead of a sandwich of only three red, green, blue layers, it now is working on 13-15 layers of data. It is further contemplated that the size of each superpixel can be defined by a target area within the field. Optionally, in exemplary aspects, the target area can range from about 0.1 acres to about 0.5 acres. While any target area may be used, the inventors have found a target area of 0.25 acres to work well. In exemplary aspects, it is contemplated that the processor can be configured to determine clusters by applying a clustering process (e.g., the SLIC process or the ISO Cluster process) to an input data set comprising estimated clay, silt, sand, and organic matter proportions within the field, as well as information concerning the elevation, topographic wetness index, and slope of the field. After the clustering process (e.g., the SLIC process or the ISO Cluster process) is applied to the input data set, the processor can be configured to produce a three-dimensional soil map with clusters corresponding to respective soil characteristics, and optionally topographic characteristics, within the field. It is contemplated that the use of clusters as disclosed herein can greatly reduce the size (and greatly increase the number of) soil management zones within a field. It is further contemplated that the continuous measurement of EC within the various depth ranges as disclosed herein can permit the identification of small soil management zones having common soil characteristics. This can be especially advantageous in maximizing yield. For example, nitrogen models would more accurately predict the present and future soil nitrogen levels across a field, allowing a grower to plan and apply the proper type and amount of fertilizer to maximize return on investment and minimize environmental effects of excess nitrogen runoff. Soils with more sand content and/or greater slopes will loss more nitrogen due to leaching, whereas soils with higher clay content and/or lesser slopes may loss more nitrogen due to denitrification. Additionally, the soil modeling may also be used to enable the highest performing hybrids may be planted in the best soil, while hybrids optimized for poorer soil conditions may be planted in such soil. Multi-hybrid and multi-variety planters are known in the art, and such planters could accomplish this level of alternative planting.

### Advantages of a Three Tier Depth Measurement

As shown in FIG. 8, the corn root zone is concentrated in a 36 inch soil zone. At various developmental stages of the plant, the soil texture at a given depth can have a significant impact on plant development. For example, a claypan or gravel layer at about a depth of 20 inches may physically impair the ability of the plant roots to spread past this depth, thereby leading to a plant that is more prone to drought or nutrient stress. However, in addition, the inventors show a surprising advantage in using a three depth measurement as versus a two depth measurement.

2014 Soil Analysis

In 2014, soil from one hundred thirty five points in eleven fields located in a cross section of the central corn belt (Nebraska, Iowa, Minnesota, Indiana and Ohio) were sampled at each of three depths, 0-30, 30-60 and 60-90 cm. Three cores per sample per depth were measured, and analysis of each sample was conducted by Midwest Laboratories. The data was analyzed at the three depth ranges of samples taken, but also analyzed assuming that only two depths, a 0-30 cm and 0-90 cm, were measured. Based on this analysis, textural changes in the 30-60 cm soil range were identified that significantly affected the way water and water-carried nutrients, such as nitrogen, would be retained and/or move through this soil. As shown in FIG. 8, corn plant roots are concentrated at this range, particular around the critical VT stage of plant development.

When the 30-60 cm values were compared with the 60-90 cm values, a significant amount of variation was observed between these two depths. Composite results showed that by adding the additional level of resolution, the absolute errors for the respect soil texture components were reduced as follows:

Sand %—6.2% average absolute error between 30-90 cm and 30-60 cm and 60-90 cm)

Silt %—5.2% average absolute error between 30-90 cm and (30-60 cm and 60-90 cm)

Clay %—4.9% average absolute error between 30-90 cm and (30-60 cm and 60-90 cm)

Organic matter %—0.5% average absolute error between 30-90 cm and (30-60 cm and 60-90 cm)

Even further, the errors that were identified were surprisingly large. Of the 135 samples, 27 sand measurements had absolute errors of 10% or more; 22 silt measurements had absolute errors of 10% or more; 19 clay measurements had absolute errors of 10% or more, and 7 organic matter measurements had absolute errors of 1% or more. In total, 26 of the 135 measurements had significant differences in one or more attributes between 30-60 cm and 60-90 cm.

As mentioned above, soil texture is an important component of crop modeling. When the two sets of data identified above were used for crop modeling, based on the model calculations of Saxton, K. E. and W. J. Rawls (2006), soil water characteristic estimates by texture and organic matter for hydrologic solutions., Soil Science Society of America Journal, 70, 1569-1578, this results in differences of at least 0.25 inches/ft of available water, 0.20 inches/hour KSAT and 4 lbs/cubic feet of bulk density. FIGS. 9-10 show these identified differences in greater detail. Accordingly, based on this data, the additional measurement in the 30-90 cm range proved beneficial between 15-20% of the time.

In an exemplary aspect, the methods and systems can be implemented on a computer 101 as illustrated in FIG. 3A and described below. By way of example, the processor 103 of system 10 can be provided as part of a computer 101 as illustrated in FIG. 3A. Similarly, the methods and systems disclosed can utilize one or more computers to perform one or more functions in one or more locations. FIG. 3A is a block diagram illustrating an exemplary operating environment 100 for performing the disclosed methods.

The present methods and systems can be operational with numerous other general purpose or special purpose computing system environments or configurations.

The processing of the disclosed methods and systems can be performed by software components. The disclosed systems and methods can be described in the general context of computer-executable instructions, such as program modules, being executed by one or more computers or other devices.

Further, one skilled in the art will appreciate that the systems and methods disclosed herein can be at least partially implemented via a general-purpose computing device in the form of a computer 101. The components of the computer 101 can comprise, but are not limited to, one or more processors or processing units 103, a system memory 112, and a system bus 113 that couples various system components including the processor 103 to the system memory 112. In the case of multiple processing units 103, the system can utilize parallel computing.

The system bus 113 represents one or more of several possible types of bus structures, including a memory bus or memory controller, a peripheral bus, an accelerated graphics port, and a processor or local bus using any of a variety of bus architectures. The bus 113, and all buses specified in this description can also be implemented over a wired or wireless network connection and each of the subsystems, including the processor 103, a mass storage device 104, an operating system 105, soil electrical conductivity software 106, soil electrical conductivity data 107, a network adapter 108, system memory 112, an Input/Output Interface 110, a display adapter 109, a display device 111, and a human machine interface 102, can be contained within one or more remote computing devices 114a,b,c at physically separate locations, connected through buses of this form, in effect implementing a fully distributed system.

The computer 101 typically comprises a variety of computer readable media. Exemplary readable media can be any available media that is accessible by the computer 101 and comprises, for example and not meant to be limiting, both volatile and non-volatile media, removable and non-removable media. The system memory 112 comprises computer readable media in the form of volatile memory, such as random access memory (RAM), and/or non-volatile memory, such as read only memory (ROM). The system memory 112 typically contains data such as soil electrical conductivity data 107 and/or program modules such as operating system 105 and soil electrical conductivity software 106 that are immediately accessible to and/or are presently operated on by the processing unit 103.

Optionally, any number of program modules can be stored on the mass storage device 104, including by way of example, an operating system 105 and soil electrical conductivity software 106. Each of the operating system 105 and soil electrical conductivity software 106 (or some combination thereof) can comprise elements of the programming and the soil electrical conductivity software 106. Soil electrical conductivity data 107 can also be stored on the mass storage device 104. Soil electrical conductivity data 107 can be stored in any of one or more databases known in the art. The databases can be centralized or distributed across multiple systems.

In another aspect, the user can enter commands and information into the computer 2101 via an input device (not shown). Input devices can be connected to the processing unit 103 via a human machine interface 102 that is coupled to the system bus 113, but can be connected by other interface and bus structures, such as a parallel port, game port, an IEEE 1394 Port (also known as a Firewire port), a serial port, or a universal serial bus (USB).

In yet another aspect, a display device 111 can also be connected to the system bus 113 via an interface, such as a display adapter 109. It is contemplated that the computer 101 can have more than one display adapter 109 and the computer 101 can have more than one display device 111. In addition to the display device 111, other output peripheral devices can comprise components such as speakers (not shown) and a printer (not shown) which can be connected to the computer 101 via Input/Output Interface 110. Any step and/or result of the methods can be output in any form to an output device. The display 111 and computer 101 can be part of one device, or separate devices.

The computer 101 can operate in a networked environment using logical connections to one or more remote computing devices 114a,b,c. By way of example, a remote computing device can be a personal computer, portable computer, smartphone, a server, a router, a network computer, a peer device or other common network node, and so on. Logical connections between the computer 101 and a remote computing device 114a,b,c can be made via a network 115, such as a local area network (LAN) and/or a general wide area network (WAN). Such network connections can be through a network adapter 108. A network adapter 108 can be implemented in both wired and wireless environments.

### Exemplary Aspects

In one exemplary aspect, disclosed herein is a system for measuring soil characteristics, comprising: a support configured to be conveyed over a ground surface; a plurality of soil engaging contacts mounted to the support, wherein the plurality of soil engaging contacts comprise at least first, second and third pairs of opposed contacts; a source for providing a current through the soil; a first sensor for measuring a first voltage resulting from the current between the first pair of contacts corresponding to a first depth range; a second sensor for measuring a second voltage resulting from the current between the second pair of contacts corresponding to a second depth range; a third sensor for measuring a third voltage resulting from the current between the third pair of contacts corresponding to a third depth range; and at least one probe configured for selective insertion within the soil, wherein the at least one probe is configured to analyze the soil within the first, second and third depth ranges.

In other exemplary aspects, the at least one probe analyzes the sand, silt and clay content of the soil within each of the first, second and third depth ranges.

In other exemplary aspects, the at least one probe analyzes the moisture content of the soil within each of the first, second and third depth ranges.

In other exemplary aspects, the at least one probe analyzes the temperature of the soil within each of the first, second and third depth ranges.

In other exemplary aspects, the at least one probe analyzes the soil electrical conductivity within each of the first, second and third depth ranges.

In other exemplary aspects, the at least one probe analyzes the soil electrical conductivity simultaneously with the measurement of the voltage by the at least three sensors.

In other exemplary aspects, the first depth range of the soil corresponds to 0 inches to about 12 inches, the second depth range of the soil corresponds to about 0 inches to about 24 inches, and the third depth range of the soil corresponds to about 0 inches to about 36 inches.

In other exemplary aspects, the at least one probe analyzes the soil compaction within each of the first, second and third depth ranges.

In other exemplary aspects, the at least one probe deploys a sample receptacle into the soil to permit collection of a soil sample within each of the first, second and third depth ranges.

In other exemplary aspects, the at least one probe is mounted approximately equidistant between at least one pair of contacts.

In other exemplary aspects, the at least one probe analyzes an insertion force required to insert the at least one probe into the soil.

In other exemplary aspects, the at least one probe comprises an optical sensor.

In other exemplary aspects, the optical sensor is an infrared sensor.

In other exemplary aspects, the infrared sensor measures spectra in the mid infrared spectral range.

In other exemplary aspects, the infrared sensor does not measure spectra outside the mid infrared spectral range.

In other exemplary aspects, the system further comprises a fourth sensor for measuring a fourth voltage resulting from the current between a fourth pair of contacts corresponding to a fourth depth.

In other exemplary aspects, the system is in operative communication with a geographic information system.

In an additional exemplary aspect, disclosed herein is a method of measuring soil characteristics, comprising: passing a current through soil at at least one test measurement location; measuring voltages resulting from the current between at least three pairs of electrical contact members that correlate to at least a first, second and third depth range; selectively inserting at least one probe within the soil at at least one probe insertion location, each probe insertion location being positioned proximate a corresponding test measurement location; measuring the first, second and third depth range of the soil using the at least one probe; correlating the voltage measurements between the corresponding pairs of electrical contact members at the first, second and third depth range of the soil with the measurements of the at least one probe at the first, second and third depth range of the soil.

In other exemplary aspects, the at least one probe is configured to measure the soil electrical conductivity within the first, second and third depth range, and the step of selectively inserting the at least one probe within the soil comprises measuring the soil electrical conductivity at the first, second and third depth range.

In other exemplary aspects, the at least one probe is configured to measure the soil electrical conductivity simultaneously with the measurement of the voltage between the at least three corresponding pairs of electrical contact members.

In other exemplary aspects, the at least one probe is configured to measure the moisture content of the soil at the first, second and third depth range, and the step of selectively inserting the at least one probe within the soil comprises measuring the moisture content of the soil at the first, second and third depth range.

In other exemplary aspects, the at least one probe is configured to measure the temperature of the soil at the first, second and third depth range, and the step of selectively inserting the at least one probe within the soil comprises measuring the temperature of the soil at the first, second and third depth range.

In other exemplary aspects, the first depth range of the soil corresponds to 0 inches to about 12 inches, the second depth range of the soil corresponds to 0 inches to about 24 inches, and the third depth range of the soil corresponds to 0 inches to about 36 inches.

In other exemplary aspects, the at least one probe comprises an optical sensor on the probe that measures the sand, silt and clay content of the soil as the probe passes through each depth range.

In other exemplary aspects, the optical sensor is an infrared sensor.

In other exemplary aspects, the infrared sensor measures spectra in the mid infrared spectral range.

In other exemplary aspects, the infrared sensor does not measure spectra outside the mid infrared spectral range.

In other exemplary aspects, the correlating comprises a regression analysis between the voltage measurements of the corresponding pairs of electrical contact members at the first, second, and third depth ranges of the soil with the sand, silt and clay content of the soil as determined by the infrared sensor.

In other exemplary aspects, the correlating comprises a regression analysis between the voltage measurements of the corresponding pairs of electrical contact members at the first, second, and third depth ranges of the soil with the organic matter content of the soil as determined by the infrared sensor.

In other exemplary aspects, the at least one probe comprises a sample receptacle, and the method further comprises selectively deploying a sample receptacle into the soil.

In other exemplary aspects, the at least one probe comprises a force sensor, and the method further comprises measuring an insertion force required to insert the at least one probe into the soil.

In other exemplary aspects, the method further comprises Super Linear Iterative Clustering (SLIC) of the sand, silt and clay values in each of the first, second, and third levels of the soil to produce one or more soil maps comprising a plurality of clusters, wherein each cluster corresponds to a respective portion of a field having common soil properties.

In other exemplary aspects, the method further comprises Super Linear Iterative Clustering (SLIC) of the organic matter values in each of the first, second, and third levels of the soil to produce one or more soil maps comprising a plurality of clusters, wherein each cluster corresponds to a respective portion of a field having common soil properties.

In a further exemplary aspect, disclosed is a method of determining soil characteristics, comprising: traversing an agricultural field in a first pass with an apparatus that applies current to soil and measures the voltage of the soil; calculating the soil electrical conductivity based on the applied current and measured voltage; interpolating the soil electrical conductivity measurements from the first pass to determine a plurality of depth ranges with similar soil electrical conductivity measurements; traversing the agricultural field with a second pass of said apparatus, wherein said second pass comprises taking at least one of a soil sample or probe measurement within each of a plurality of depth ranges with similar soil electrical conductivity measurements to determine at least one soil characteristic; calculating a regression equation between the soil electrical conductivity measurements and the at least one soil characteristic determined by the at least one soil sample or probe measurement within each plurality of depth ranges with similar soil electrical conductivity measurements; and modeling the at least one soil characteristic at each of the plurality of depth ranges based on the regression equation.

In other exemplary aspects, the at least one soil characteristic comprises at least one of a sand, silt or clay content of the soil.

In other exemplary aspects, the at least one probe measurement comprises an infrared measurement.

In other exemplary aspects, the infrared measurement comprises an infrared measurement in the mid infrared spectral range.

In other exemplary aspects, the at least one soil characteristic comprises the sand, silt and clay content of the soil.

In other exemplary aspects, the at least one probe measurement comprises an infrared measurement.

In other exemplary aspects, the infrared measurement comprises an infrared measurement in the mid infrared spectral range.

In other exemplary aspects, the at least one soil characteristic comprises the organic matter content of the soil.

In other exemplary aspects, the at least one probe measurement comprises an infrared measurement.

In other exemplary aspects, the infrared measurement comprises an infrared measurement in the mid infrared spectral range.

In other exemplary aspects, the at least one probe measurement comprises a measurement of soil moisture and soil temperature.

In other exemplary aspects, the at least one probe measurement comprises a measurement of the salinity of the soil.

In other exemplary aspects, the step of calculating the regression equation comprises calculating the regression equation between the soil electrical conductivity measurements and the at least one soil characteristic, wherein the soil characteristics comprise soil moisture, soil temperature and the sand, silt and clay content of the soil.

In other exemplary aspects, interpolating the soil electrical conductivity measurements of the first pass comprises determining spatial zones with similar soil electrical conductivity measurements.

In other exemplary aspects, modeling the at least one soil characteristic at each of the plurality of depth ranges based on the regression equation further comprises Super Linear Iterative Clustering (SLIC) the sand, silt and clay values at each of the plurality of depth ranges.

In other exemplary aspects, the plurality of depth ranges comprises at least three depth ranges.

In other exemplary aspects, the method further comprises Super Linear Iterative Clustering (SLIC) at least one topographical characteristic of the soil to produce a soil map comprising a plurality of clusters, wherein each cluster corresponds to a respective portion of the agricultural field having common soil and topographical properties.

In other exemplary aspects, modeling the at least one soil characteristic at each of the plurality of depth ranges based on the regression equation further comprises Super Linear Iterative Clustering (SLIC) the organic matter content at each of the plurality of depth ranges.

In still another exemplary aspects, disclosed herein is a system for measuring soil characteristics, comprising: a support configured to be conveyed over a ground surface; a single current source for providing a current through the soil; and a plurality of soil engaging contacts mounted to the support, wherein the plurality of soil engaging contacts comprise at least one pair of opposed contacts each comprising a voltage sensor; at least one probe configured for insertion within the soil, wherein the at least one probe comprises a voltage sensor.

In other exemplary aspects, the single current source is a pair of opposed contacts mounted to the support.

In other exemplary aspects, the probe is approximately equidistant between at least one pair of opposed contacts comprising a voltage sensor.

In other exemplary aspects, the probe is approximately equidistant between all pairs of opposed contacts comprising a voltage sensor.

In other exemplary aspects, the voltage sensor on the opposed contacts and the voltage sensor on the probe each measure the voltage drop from the single current source.

In other exemplary aspects, the probe is mounted to the support.

While the methods and systems have been described in connection with preferred embodiments and specific examples, it is not intended that the scope be limited to the particular embodiments set forth, as the embodiments herein are intended in all respects to be illustrative rather than restrictive.

2015 Field Study

In 2015 a trial was performed on 14 fields spread across the Midwestern United States (Nebraska, Kansas, Iowa, Missouri, Illinois, Indiana, and Ohio). These fields were selected for their diversity of soil characteristics and geomorphology, and ranged from dark prairie soils to sandy river bottoms to muck soils. In each field electrical conductivity (EC) was measured on 60 foot transects at four depths: 0-2 inches, 0-12 inches, 0-24 inches, and 0-36 inches. 16 points were selected in each field on the same 60 foot EC transects based on their variability of EC in the 0-12 inches range. At each of these points a core of soil was removed to 36 inches depth, split into three 1 foot segments, and sent to a soil analysis laboratory for chemical and physical analysis, including for Organic Matter, Cation Exchange Capacity (CEC), clay %, silt %, and sand %. Instantaneous EC measured at the spatial location of the sample, along with terrain slope & curvature, red and infrared readings from a separate sensor, were then joined in a table with the lab results for each of the three depths (0-12 inches, 12 to 24 inches, and 24 to 36 inches) by field identification.

Six points in each field were selected as training data in a Random Forest regression model, and the remaining ten points were used for comparison of estimated vs measured Organic Matter, CEC, clay, silt, and sand %'s across all fields and depths. The results of the regression analysis were:

| Attribute | R\hat{ }2 |
|---|---|
| Organic Matter | 0.57 |
| CEC | 0.88 |
| Clay % | 0.87 |
| Silt % | 0.87 |
| Sand % | 0.90 |

While performing this analysis, a variable importance report was generated to determine the contribution of each variable to explaining the variability of the measured values. Greater node purity values mean more significance was found for that particular attribute. FIG. 11a through 11e show that in general, EC measurements in the 0-36″ depth (labeled “EC_DP”) contributed the greatest level of variability explanation, followed closely by EC measurements at 0-24″ (labeled “EC_02”) and then EC measurements at 0-12″ (labeled “EC_SH”). This shows that EC measurements in the 0-24″ depth provided a significant contribution towards explaining variability and allowed the Random Forest model to generate better estimates than if the 0-24″ depth measurement was not included.

This analysis shows that a relationship between measured soil properties, such as organic matter, CEC, clay, silt and sand % and proximal measurements taken by a machine, like electrical conductivity at various depths, can be made through regression techniques and provide sufficient accuracy as to provide a crop model with highly accurate estimates of soil properties when no actual measurements are available. This allows the use of estimated soil properties as inputs into a crop model across large areas of fields where no actual measurements were taken.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; the number or type of embodiments described in the specification.

Although several embodiments of the invention have been disclosed in the foregoing specification, it is understood by those skilled in the art that many modifications and other embodiments of the invention will come to mind to which the invention pertains, having the benefit of the teaching presented in the foregoing description and associated drawings. It is thus understood that the invention is not limited to the specific embodiments disclosed hereinabove, and that many modifications and other embodiments are intended to be included within the scope of the appended claims. Moreover, although specific terms are employed herein, as well as in the claims which follow, they are used only in a generic and descriptive sense, and not for the purposes of limiting the described invention, nor the claims which follow.

What is claimed is:

1. A system for measuring soil characteristics, comprising:
a support configured to be conveyed over a ground surface;
a plurality of soil engaging contacts mounted to the support, wherein the plurality of soil engaging contacts comprise at least first, second and third pairs of opposed contacts;
a source for providing a current through the soil;
a first sensor for measuring a first voltage resulting from the current between the first pair of contacts corresponding to a first depth range;
a second sensor for measuring a second voltage resulting from the current between the second pair of contacts corresponding to a second depth range;
a third sensor for measuring a third voltage resulting from the current between the third pair of contacts corresponding to a third depth range; and
at least one probe configured for selective insertion within the soil, wherein the at least one probe is configured to analyze the soil within the first, second and third depth ranges.

2. The system of claim 1, wherein the at least one probe analyzes the sand, silt and clay content of the soil within each of the first, second and third depth ranges.

3. The system of claim 1, wherein the at least one probe analyzes the moisture content of the soil within each of the first, second and third depth ranges.

4. The system of claim 1, wherein the at least one probe analyzes the temperature of the soil within each of the first, second and third depth ranges.

5. The system of claim 1, wherein the at least one probe analyzes the soil electrical conductivity within each of the first, second and third depth ranges.

6. The system of claim 5, wherein the at least one probe analyzes the soil electrical conductivity simultaneously with the measurement of the voltage by the at least three sensors.

7. The system of claim 1, wherein the first depth range of the soil corresponds to 0 inches to about 12 inches, wherein the second depth range of the soil corresponds to about 0 inches to about 24 inches, and wherein the third depth range of the soil corresponds to about 0 inches to about 36 inches.

8. The system of claim 1, wherein the at least one probe analyzes the soil compaction within each of the first, second and third depth ranges.

9. The system of claim 1, wherein the at least one probe deploys a sample receptacle into the soil to permit collection of a soil sample within each of the first, second and third depth ranges.

10. The system of claim 1, wherein the at least one probe is approximately equidistant between at least one pair of contacts.

11. The system of claim 1, wherein the at least one probe analyzes an insertion force required to insert the at least one probe into the soil.

12. The system of claim 1, wherein the at least one probe comprises an optical sensor.

13. The system of claim 12, wherein the optical sensor is an infrared sensor.

14. The system of claim 13, wherein the infrared sensor measures spectra in the mid infrared spectral range.

15. The system of claim 13, wherein the infrared sensor does not measure spectra outside the mid infrared spectral range.

16. The system of claim 1, further comprising a fourth sensor for measuring a fourth voltage resulting from the current between a fourth pair of contacts corresponding to a fourth depth.

17. The system of claim 1, wherein the system is in operative communication with a geographic information system.

18. A method of measuring soil characteristics, comprising:
passing a current through soil at at least one test measurement location;
measuring voltages resulting from the current between at least three pairs of electrical contact members that correlate to at least a first, second and third depth range;
selectively inserting at least one probe within the soil at at least one probe insertion location, each probe insertion location being positioned proximate a corresponding test measurement location;
measuring the first, second and third depth range of the soil using the at least one probe;
correlating the voltage measurements between the corresponding pairs of electrical contact members at the first, second and third depth range of the soil with the measurements of the at least one probe at the first, second and third depth range of the soil.

19. The method of claim 18, wherein the at least one probe is configured to measure the soil electrical conductivity within the first, second and third depth range, and wherein the step of selectively inserting the at least one probe within the soil comprises measuring the soil electrical conductivity at the first, second and third depth range.

20. The method of claim 19, wherein the at least one probe is configured to measure the soil electrical conductivity simultaneously with the measurement of the voltage between the at least three corresponding pairs of electrical contact members.

21. The method of claim 18, wherein the at least one probe is configured to measure the moisture content of the soil at the first, second and third depth range, and wherein the step of selectively inserting the at least one probe within the soil comprises measuring the moisture content of the soil at the first, second and third depth range.

22. The method of claim 18, wherein the at least one probe is configured to measure the temperature of the soil at the first, second and third depth range, and wherein the step of selectively inserting the at least one probe within the soil comprises measuring the temperature of the soil at the first, second and third depth range.

23. The method of claim 18, wherein the first depth range of the soil corresponds to 0 inches to about 12 inches, wherein the second depth range of the soil corresponds to 0 inches to about 24 inches, and wherein the third depth range of the soil corresponds to 0 inches to about 36 inches.

24. The method of claim 18, wherein the at least one probe comprises an optical sensor on the probe that measures the sand, silt and clay content of the soil as the probe passes through each depth range.

25. The method of claim 24, wherein the optical sensor is an infrared sensor.

26. The method of claim 25, wherein the infrared sensor measures spectra in the mid infrared spectral range.

27. The method of claim 25, wherein the infrared sensor does not measure spectra outside the mid infrared spectral range.

28. The method of claim 25, wherein the correlating comprises a regression analysis between the voltage measurements of the corresponding pairs of electrical contact members at the first, second, and third depth ranges of the soil with the sand, silt and clay content of the soil as determined by the infrared sensor.

29. The method of claim 25, wherein the correlating comprises a regression analysis between the voltage measurements of the corresponding pairs of electrical contact members at the first, second, and third depth ranges of the soil with the organic matter content of the soil as determined by the infrared sensor.

30. The method of claim 18, wherein the at least one probe comprises a sample receptacle, and wherein the method further comprises selectively deploying a sample receptacle into the soil.

31. The method of claim 18, wherein the at least one probe comprises a force sensor, and wherein the method further comprises measuring an insertion force required to insert the at least one probe into the soil.

32. The method of claim 18, further comprising Super Linear Iterative Clustering (SLIC) of the sand, silt and clay values in each of the first, second, and third levels of the soil to produce one or more soil maps comprising a plurality of clusters, wherein each cluster corresponds to a respective portion of a field having common soil properties.

33. The method of claim 18, further comprising Super Linear Iterative Clustering (SLIC) of the organic matter values in each of the first, second, and third levels of the soil to produce one or more soil maps comprising a plurality of clusters, wherein each cluster corresponds to a respective portion of a field having common soil properties.
